(19) United States
(12) Patent Application Publication
(10) Pub. No.: US 2015/0344651 A1
(43) Pub. Date: Dec. 3, 2015

(54) PROCESS FOR MANUFACTURING GAS BARRIER FILM

(71) Applicant: Konica Minolta, Inc., Tokyo (JP)

(72) Inventor: Maiko KONDO, Hino-shi, Tokyo (JP)

(21) Appl. No.: 14/759,838

(22) PCT Filed: Jan. 9, 2014
(86) PCT No.: PCT/JP2014/050215

§ 371 Date: Jul. 8, 2015

(30) Foreign Application Priority Data
Jan. 11, 2013 (JP) 2013-003636

(51) Int. Cl. C08J 7/06; B05D 3/06

(52) U.S. Cl. CPC C08J 7/06; B05D 3/066; C08J 2300/22; C08J 2400/22

(57) ABSTRACT

An object of the present invention is to provide a process for manufacturing a gas barrier film which exhibits excellent storage stability. The process for manufacturing a gas barrier film of the present invention is characterized by including: (a) forming, on a substrate, an unmodified layer A which contains a silicon compound having a structure represented by the following General Formula (1) —[Si(R¹)(R²)—N(R³)]ₙ—; (b) forming a layer B which contains a compound having an oxygen element or a nitrogen element on the unmodified layer A; and (c) irradiating with vacuum ultraviolet ray from the layer B side to modify the unmodified layer A.

### TECHNICAL FIELD

The present invention relates to a process for manufacturing a gas barrier film. More specifically, it relates to a process for manufacturing a gas barrier film with excellent stability, in particular, excellent stability under high temperature and high moisture conditions.

### BACKGROUND ART

Hitherto, a gas barrier film is used for packaging of foods or industrial products. Meanwhile, as actual application of a liquid crystal display device or a solar cell is made in recent years, a strong desire for a flexible substrate arises as it has a light and not easily breakable property. A gas barrier film is also used as a substrate member of a liquid crystal display device or a solar cell.

Compared to packaging of foods or industrial products, the gas barrier film as a substrate member of a liquid crystal display device or a solar cell is required to have an even higher gas barrier property. For such reasons, development of a gas barrier film having more excellent gas barrier property is in need.

Meanwhile, as a process for manufacturing a gas barrier film, known are a chemical vapor deposition method (plasma CVD method) in which an organosilicon compound is used and a film is formed on a substrate while carrying out oxidation with oxygen plasma at reduced pressure, and a sputtering method by which metal Si is evaporated using a semiconductor laser to deposit it on a substrate in the presence of oxygen. However, these processes have a problem in terms of productivity, since a film is formed at reduced pressure, they are not suitable for continuous production and a large-size apparatus is required, or the like.

In order to solve these problems, various attempts have been made in the field of manufacture of a gas barrier film under the purpose of enhancing the productivity, for example, a process by which a silicon-containing compound is coated to form a silicon oxide thin film via modification of the coating film, and a process by which a film is formed under atmospheric pressure with generation of plasma under atmospheric pressure by a chemical vapor phase growing method (CVD method).

For example, as a silicon oxide film which can be generally prepared by a solution process, known is a preparation technique called a sol-gel method employing an alkoxide compound as raw material. However, heating to high temperature is necessary, and large shrinkage in volume occurs in the process of dehydration condensation reaction, and thus there is problem that a large number of defects easily occur in the film.

As another process, it is described in Patent Literature 1 that a transparent coating film of glass type is formed on a substrate by irradiating a polysilazane layer, which is formed by using a silazane compound having a silazane structure (Si—N) as a basic structure, with VUV radiation ray containing wavelength component of <230 nm and UV radiation ray containing wavelength component of 230 to 300 nm. According to this method, a silicon oxide film is produced at a relatively low temperature by allowing an oxidization reaction to proceed by active oxygen or ozone while directly dissociating the atomic bonds by the action of only photons, which is called a photon process, using light energy of 100 to 200 nm called vacuum ultraviolet ray (VUV ray) that is higher than the atomic bonding force in a silazane compound. In this regard, since the reaction in this case is not a dehydration-condensation reaction but a direct substitution reaction from nitrogen to oxygen, mass yield before and after the reaction is as large value as 80% to 100%, and thus a dense film having fewer defects in the film, which are caused by volume shrinkage, can be obtained. However, the film obtained by the process described in Patent Literature 1 above has a problem that scratch resistance is poor.

For the purpose of solving the aforementioned problems, a gas barrier film obtained by forming a specific overcoat layer on a gas barrier layer, which is formed by performing a modification treatment of a coating film of a silicon compound-containing liquid with a polysilazane skeleton, is reported (for example, Patent Literature 2).

### CITATION LIST

### Patent Literatures

Patent Literature 1: JP 2009-503157 W (corresponding to US 2010/0166977 A1)
Patent Literature 2: JP 2011-194587 A

### SUMMARY OF INVENTION

### Technical Problem

However, although the gas barrier film described in Patent Literature 2 exhibits a slightly improved gas barrier property, it is insufficient for application to an organic electroluminescence in which water vapor transmission rate (WVTR) of 10⁻⁵ to 10⁻⁶ g/m²/day is required. Furthermore, the gas barrier film described in Patent Literature 2 has a problem that it has poor storage stability, in particular, poor storage stability under harsh conditions (high temperature and high moisture conditions).

Thus, the present invention has been made under the circumstances described above, and an object thereof is to provide a process for manufacturing a gas barrier film with excellent storage stability, in particular, excellent storage stability under harsh conditions (high temperature and high moisture conditions).

### Solution to Problem

In order to solve the problems described above, inventors of the present invention conducted intensive studies. As a result, they found that a significantly lower gas barrier property after storage under high temperature and high moisture conditions is caused by a change in composition of the gas barrier layer. As a result of further intensive studies, they found that, by performing a modification of a layer containing a silazane compound via a layer which contains a compound having an oxygen element or a nitrogen element, the aforementioned object can be achieved. The present invention is completed accordingly.

That is, in order to achieve at least one of the above objects, a process for manufacturing a gas barrier film reflecting one aspect of the present invention includes:

(a) forming, on a substrate, an unmodified layer A which contains a silicon compound having a structure represented by the following General Formula (1),

[Chemical Formula 1]

—[Si(R¹)(R²)—N(R³)]ₙ— General Formula (1)

wherein R¹, R², and R³ each independently represent a hydrogen atom, a substituted or unsubstituted alkyl group, a substituted or unsubstituted aryl group, a substituted or unsubstituted vinyl group, or a substituted or unsubstituted (trialkoxysilyl)alkyl group;

(b) forming a layer B which contains a compound having an oxygen element or a nitrogen element on the unmodified layer A; and

(c) irradiating with vacuum ultraviolet ray from the layer B side to modify the unmodified layer A.

### BRIEF DESCRIPTION OF DRAWINGS

FIG. 1 is a schematic cross-sectional view illustrating one embodiment of the layer configuration of the gas barrier film of the present invention, wherein a reference numeral 11 represents a gas barrier film; a reference numeral 12 represents a substrate; a reference numeral 13 represents a gas barrier layer; and a reference numeral 14 represents a layer B, respectively.

### DESCRIPTION OF EMBODIMENTS

The present invention relates to a process for manufacturing a gas barrier film including

(a) forming, on a substrate, an unmodified layer A (herein, it is also simply referred to as a “unmodified layer A” or “layer A”) which contains a silicon compound having a structure represented by the following General Formula (1) (herein, it is also simply referred to as a “silicon compound of the formula (1)”) [Step (a)],

[Chemical Formula 2]

—[Si(R¹)(R²)—N(R³)]ₙ— General Formula (1)

wherein R¹, R², and R³ each independently represent a hydrogen atom, a substituted or unsubstituted alkyl group, a substituted or unsubstituted aryl group, a substituted or unsubstituted vinyl group, or a substituted or unsubstituted (trialkoxysilyl)alkyl group,

(b) forming a layer B which contains a compound having an oxygen element or a nitrogen element (herein, it is also simply referred to as a “O/N containing compound”) on the unmodified layer A [Step (b)], and

(c) performing irradiation with vacuum ultraviolet ray (herein, it is also simply referred to as “VUV ray”) from the layer B side to modify the unmodified layer A (herein, it is also simply referred to as “VUV irradiation”) [Step (c)]. Meanwhile, herein, the modified layer which is formed by modifying the unmodified layer A during Step (c) is also referred to as a “modified layer A” or a “gas barrier layer.”

The present invention is characterized in that the unmodified layer A is modified by laminating the unmodified layer A which contains a silicon compound having a polysilazane skeleton (—[Si(R¹)(R²)—N(R³)]ₙ—) and the layer B which contains at least an oxygen element or a nitrogen element on top of the unmodified layer A and performing irradiation of VUV ray from above the layer B to the unmodified layer A, that is, via the layer B. The gas barrier film manufactured by the process described above can exhibit excellent storage stability, in particular, excellent storage stability under harsh conditions (high temperature and high moisture conditions). Furthermore, the gas barrier film has a high gas barrier property (for example, low oxygen transmission property and low water vapor transmission property). Herein, the mechanism for exhibiting the aforementioned working effects by the constitution of the present invention is believed to be the same as those described below. However, the present invention is not limited to those described below.

Specifically, when a layer of a silicon compound having a polysilazane skeleton (polysilazane layer) is irradiated with VUV ray, as atomic bonds are broken and a reaction progresses, it is generally modified to a silicon oxide or silicon oxynitride film. Herein, when the modification of the unmodified layer A is performed by direct VUV irradiation of the polysilazane layer (not intermediated by the layer B), the surface of the polysilazane layer receives more easily the VUV ray energy than the inside of the polysilazane layer so that a huge difference in modification speed is generated between the surface and the inside of the polysilazane layer. In other words, as there is a state in which modification progresses in order from the surface to the inside of the polysilazane layer, freedom level of reaction active species such as Si radical generated inside the polysilazane layer is lowered, and they remain as a dangling bond inside the gas barrier layer. For such reasons, the dangling bond cannot be reduced even when the energy of VUV ray for irradiation or the like is increased. On the other hand, when modification of the unmodified layer A (silicon compound) is performed via the layer B containing an oxygen element source or a nitrogen element source as described in the present invention, the layer B melts according to VUV irradiation to yield a mixing of constitutional compound of each layer at an interface between the unmodified layer A (the polysilazane layer) and the layer B. Accordingly, a state in which the polysilazane concentration is lower at an interface between the unmodified layer A and the layer B compared to the inside of the layer A is yielded. As such, a difference in modification speed between the surface and the inside of the polysilazane layer becomes smaller. Furthermore, as the layer B contains an oxygen element source or a nitrogen element source, the reaction of radical species that are generated inside the layer A can be promoted. Accordingly, it is believed that a gas barrier layer having few dangling bonds is formed. Furthermore, the gas barrier layer obtained by such modification treatment has a little change in composition of the gas barrier layer even after storage under high temperature and high moisture conditions, and thus it can exhibit excellent storage stability.

Thus, the gas barrier film manufactured by the process of the present invention has excellent storage stability, in particular, excellent storage stability under harsh conditions (high temperature and high moisture conditions. Furthermore, as the gas barrier film manufactured by the process of the present invention exhibits an excellent gas barrier property like water vapor transmission rate (WVTR) of 10⁻⁵ to 10⁻⁶ g/m²/day, it can be preferably used for an organic electroluminescence or the like.

Hereinbelow, the embodiments of the present invention are described. However, the present invention is not limited to the following embodiments. Meanwhile, the dimensional ratio in the drawings is exaggerated for the sake of convenience of explanation, and it may be different from actual ratio.

Furthermore, as described herein, “X to Y” representing a range means “X or more and Y or less” and “weight” and “mass”, “% by weight” and “% by mass”, and “parts by weight” and “parts by mass” are treated as synonyms. Furthermore, unless specifically described otherwise, the operations and measurements of physical properties are performed under conditions of room temperature (20 to 25° C.)/relative humidity of 40 to 50%.

<Gas Barrier Film>

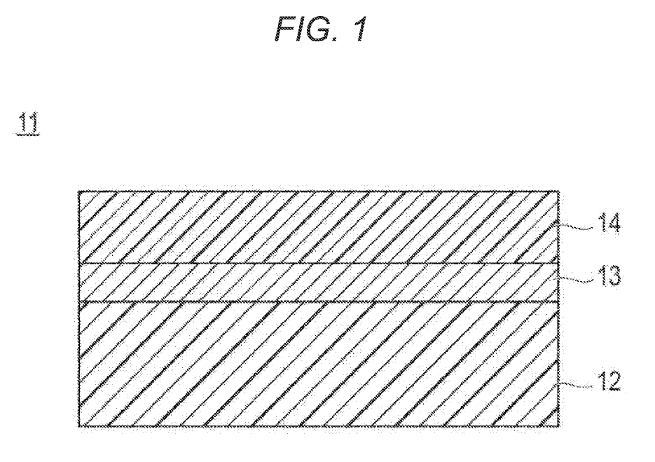

Layer configuration of the gas barrier film of the present invention is described in view of FIG. 1.

In FIG. 1, the gas barrier film 11 of the present invention consists of the substrate 12 and the gas barrier layer 13 and the layer B14 that are formed in order on top of the substrate 12. Meanwhile, the “gas barrier layer” means a layer obtained after a modification treatment of the unmodified layer A (Step (c)). Furthermore, the gas barrier film of the present invention may have a laminate structure. In case of having a laminate structure, it is sufficient that least one gas barrier layer is manufactured by the above Step (a) to Step (c). Thus, the gas barrier film of the present invention may have a laminate structure having the gas barrier layer manufactured by the above Step (a) to Step (c) and a gas barrier layer obtained by modification of the unmodified layer A only or a layer formed by vapor deposition. Meanwhile, on the gas barrier film of the present invention, a functionalized layer such as an organic layer, a protective layer, a water absorbing layer, an antistatic layer, a smooth layer, or a bleed out layer can be further formed, if required.

[Step (a)]

In Step (a), the unmodified layer A which contains a silicon compound having a structure represented by the aforementioned General Formula (1) is formed.

(Substrate)

As a substrate, a plastic film or a plastic sheet is generally used, and a film or a sheet consisting of a colorless and transparent resin is preferably used. The plastic film to be used is not particularly limited in terms of a material and thickness as long as it can support a gas barrier layer, a hard coat layer, or the like, and it can be suitably selected depending on purpose of use or the like. Specific examples of the plastic film include a thermoplastic resin such as a polyester resin, a methacryl resin, a methacrylic acid-maleic acid copolymer, a polystyrene resin, a transparent fluororesin, polyimide, a fluorinated polyimide resin, a polyamide resin, a polyamide imide resin, a polyether imide resin, a cellulose acylate resin, a polyurethane resin, a polyether ether ketone resin, a polycarbonate resin, an alicyclic polyolefin resin, a polyarylate resin, a polyether sulfone resin, a polysulfone resin, a cycloolefin copolymer, a fluorene ring-modified polycarbonate resin, an alicyclic modified polycarbonate resin, a fluorene ring-modified polyester resin, or an acryloyl compound.

When the gas barrier film according to the present invention is used as a substrate of an electronic device such as an organic EL element, the substrate preferably consists of a material with heat resistance. Specifically, a resin substrate having linear expansion coefficient of 15 ppm/K or more and 100 ppm/K or less and glass transition temperature (Tg) of 100° C. or higher and 300° C. or lower is used. This substrate satisfies the conditions that are required for use in an electronic compartment or a laminate film for display. In other words, when the gas barrier film of the present invention is used for those applications, the gas barrier film may be exposed to a step at 150° C. or higher. In that case, when the linear expansion coefficient of a substrate of the gas barrier film is more than 100 ppm/K, the substrate dimension becomes unstable when the gas barrier film is subjected to the process at aforementioned temperature. As a result, accompanying thermal expansion and shrinkage, problems like deteriorated blocking performance or no resistance to a heating step may easily occur. On the other hand, when it is lower than 15 ppm/K, flexibility may be deteriorated as the film breaks like glass.

Tg or linear expansion coefficient of a substrate can be controlled by additives or the like. Specific examples of a preferred thermoplastic resin which can be used as a substrate include polyethylene terephthalate (PET: 70° C.), polyethylene naphthalate (PEN: 120° C.), polycarbonate (PC: 140° C.), alicyclic polyolefin (for example, ZEONOR (registered trademark) 1600 manufactured by Zeon Corporation: 160° C.), polyarylate (PAr: 210° C.), polyether sulfone (PES: 220° C.), polysulfone (PSF: 190° C.), cycloolefin copolymer (COC: compound described in JP 2001-150584 A: 162° C.), polyimide (for example, NEOPRIM (registered trademark) manufactured by Mitsubishi Gas Chemical Company, Inc.: 260° C.), polycarbonate modified with fluorene ring (BCF-PC: compound described in JP 2000-227603 A: 225° C.), polycarbonate modified with alicycle (IP-PC: compound described in JP 2000-227603 A: 205° C.), and an acryloyl compound (compound described in JP 2002-80616 A: 300° C. or higher) (value in the parenthesis indicates Tg).

The plastic film is preferably transparent from the viewpoint that the gas barrier film of the present invention is used an electronic device such as an organic EL element. In other words, the light transmittance is generally 80% or more, preferably 85% or more, and more preferably 90% or more. The light transmittance can be obtained according to the method described in JIS K7105: 1981, that is, total light transmittance and scattered light amount are measured by using an integration type sphere transmittance-measuring apparatus and it can be obtained by subtracting diffused transmittance from the total light transmittance.

Meanwhile, even when the gas barrier film according to the present invention is used for display application, the transparency is not always required if it is not installed on an observation side or the like. As such, an opaque material can be used as the plastic film for such case. Examples of the opaque material include polyimide, polyacrylonitrile, and a known liquid crystal polymer.

Thickness of the plastic film which is used for the gas barrier film according to the present invention is not particularly limited as it is suitably selected depending on use. However, it is typically 1 to 800 μm, and preferably 10 to 200 μm. The plastic film may also include a functional layer like a transparent conductive layer, a primer layer, or the like. With regard to the functional layer, those described in paragraphs [0036] to [0038] of JP 2006-289627 A can be suitably employed in addition to those described above.

The substrate preferably has a surface with high smoothness. With regard to the smoothness of a surface, average surface roughness (Ra) is preferably 2 nm or less. Although it is not particularly limited, the lower limit is 0.01 nm or more from the viewpoint of actual application. If necessary, it is possible that both surfaces of a substrate or at least a surface for forming the gas barrier layer is polished to enhance the smoothness.

Furthermore, a substrate in which the aforementioned resin or the like is used may be either a non-stretched film or a stretched film.

The substrate to be used in the present invention can be produced by a previously well-known general method. For example, by melting a resin as a material by an extruder, and extruding the molten resin through a ring die or a T-die followed by rapid cooling, an unstretched substrate, which is substantially amorphous and is not oriented, can be produced. Furthermore, it is also possible that an unstretched substrate is stretched in the substrate running direction (vertical axis) or in the direction at right angle to the substrate running direction (horizontal axis) by a commonly known method such as an uniaxial stretching method, a tenter type individual biaxial stretching method, a tenter type simultaneous biaxial stretching method or a tubular type simultaneous biaxial stretching method to produce a stretched substrate. In this case, a stretching ratio is preferably 2 to 10 times in each of the vertical axis direction and the horizontal axis direction, although the ratio can be selected appropriately depending on the resin as a substrate material.

At least a substrate surface side for forming the gas barrier layer according to the present invention can be subjected to various known treatments for improving adhesiveness, for example, an excimer treatment, a corona discharge treatment, a flame treatment, an oxidation treatment, or a plasma treatment, or lamination of a primer layer that is described below. If necessary, those treatments are preferably performed in combination.

(Unmodified Layer A)

The unmodified layer A contains a silicon compound which has a structure shown by the following General Formula (1). The silicon compound of the formula (1) is a polymer which has a silicon-nitrogen (Si—N) bond in the structure as shown in General Formula (1), and it is a ceramic precursor inorganic polymer such as SiO₂, Si₃N₄, or an intermediate solid solution of SiOₓN_{y} containing a bond such as Si—N, Si—H, and N—H. Meanwhile, the silicon compound of the formula (1) herein is also described as “polysilazane”. Herein, the unmodified layer A may contain only one type of the silicon compound having a structure represented by the formula (1) or two or more types of the silicon compound of the formula (1). Furthermore, the unmodified layer A (gas barrier layer) may be present as a single layer or laminated with two or more layers on a substrate.

[Chemical Formula 3]

—[Si(R¹)(R²)—N(R³)]ₙ— General Formula (1)

In General Formula (1), R¹, R², and R³ represent a hydrogen atom or a substituted or unsubstituted alkyl group, aryl group, vinyl group, or (trialkoxysilyl)alkyl group. In this case, R¹, R², and R³ each may be the same or different from each other. Examples of the alkyl group described herein include a linear, branched, or cyclic alkyl group having 1 to 8 carbon atoms. More specific examples thereof include a methyl group, an ethyl group, a n-propyl group, an isopropyl group, a n-butyl group, an isobutyl group, a sec-butyl group, a tert-butyl group, a n-pentyl group, an isopentyl group, a neopentyl group, a n-hexyl group, a n-heptyl group, a n-octyl group, a 2-ethylhexyl group, a cyclopropyl group, a cyclopentyl group, and a cyclohexyl group. Examples of the aryl group include an aryl group having 6 to 30 carbon atoms. More specific examples thereof include a non-fused hydrocarbon group such as a phenyl group, a biphenyl group, or a terphenyl group; and a fused polycyclic hydrocarbon group such as a pentalenyl group, an indenyl group, a naphthyl group, an azulenyl group, a heptalenyl group, a biphenylenyl group, a fluorenyl group, an acenaphthylenyl group, a pleiadenyl group, an acenaphthenyl group, a phenalenyl group, a phenanthryl group, an anthryl group, a fluoranethenyl group, an acephenanthrylenyl group, an aceanthrylenyl group, a triphenylenyl group, a pyrenyl group, a chrysenyl group, and a naphthacenyl group. Examples of the trialkoxysilyl)alkyl group include an alkyl group having 1 to 8 carbon atoms in which a silyl group substituted with an alkoxy group having 1 to 8 carbon atoms is included. More specific examples thereof include a 3-(triethoxysilyl)propyl group and a 3-(trimethoxysilyl)propyl group. The substituent group which may be present depending on a case on the aforementioned R¹ to R³ is not particularly limited, and examples thereof include an alkyl group, a halogen atom, a hydroxy group (—OH), a mercapto group (—SH), a cyano group (—CN), a sulfo group (—SO₃H), a carboxy group (—COOH), and a nitro group (—NO₂). Meanwhile, the substituent group which may be present depending on a case is not the same as the R¹ to R³ to be substituted. For example, when R¹ to R³ are an alkyl group, it is not further substituted with an alkyl group. Among them, R¹, R² and R³ are preferably a hydrogen atom, a methyl group, an ethyl group, a propyl group, an isopropyl group, a butyl group, an isobutyl group, a tert-butyl group, a phenyl group, a vinyl group, a 3-(triethoxysilyl)propyl group, or a 3-(trimethoxysilylpropyl) group. It is particularly preferable to have perhydropolysilazane (PHPS) in which all of R¹, R², and R³ are a hydrogen atom. The gas barrier layer (gas barrier film) formed by such polysilazane exhibits high density.

Furthermore, in the above General Formula (1), n is an integer representing the number of constitutional unit of the formula: —[Si(R¹)(R²)—N(R³)]— and it is preferably determined such that the polysilazane having a structure represented by General Formula (1) has a number average molecular weight of 150 to 150,000 g/mol.

From the viewpoint of film density of a gas barrier layer, perhydropolysilazane in which all of R¹, R², and R³ are a hydrogen atom is particularly preferable. The perhydropolysilazane is believed to have a structure in which a linear chain structure and a ring structure having 6- and 8-membered ring as a main ring are present. The molecular weight of perhydropolysilazane is about 600 to 2,000 (polystyrene conversion value based on gel permeation chromatography) in terms of a number average molecular weight (Mn). The perhydropolysilazane is a material of liquid or solid. Polysilazane is commercially available in a solution state in which it is dissolved in an organic solvent. The commercially available product itself can be used as a coating liquid containing polysilazane. Examples of the commercially available polysilazane solution include AQUAMICA (registered trademark) NN120-10, NN120-20, NAX120-20, NN110, NN310, NN320, NL110A, NL120A, NL120-20, NL150A, NP110, NP140, SP140 and the like, that are manufactured by AZ Electronic Materials.

The silicon compound according to the present invention may contain other constitutional unit in addition to the constitutional unit of the formula: —[Si(R¹) R²)—N(R³)]—. The silicon compound is not particularly limited, but a silicon compound having the structure represented by General Formula (4) or (5) is preferably used, for example.

[Chemical Formula 4]

—[Si(R¹)(R²)—N(R³)]ₙ—[Si(R⁴)(R⁵)—N(R⁶)]ₚ— General Formula (4)

[Chemical Formula 5]

—[Si(R¹)(R²)—N(R³)]ₙ—[Si(R⁴)(R⁵)—N(R⁶)]ₚ—[Si(R⁷)(R⁸)—N(R⁹)]_{q}— General Formula (5)

In General Formula (4), R′, R², R³, R⁴, R⁵, and R⁶ represent a hydrogen atom or a substituted or unsubstituted alkyl group, aryl group, vinyl group, or (trialkoxysilyl)alkyl group. In this case, R¹, R², R³, R⁴, R⁵, and R⁶ each may be the same or different from each other. Because the aforementioned substituted or unsubstituted alkyl group, aryl group, vinyl group, or (trialkoxysilyl)alkyl group are the same as those defined for General Formula (1), explanations therefor are omitted.

Furthermore, in the above General Formula (4), n and p are an integer and they are preferably determined such that the polysilazane having a structure represented by General Formula (4) has a number average molecular weight of 150 to 150,000 g/mol. Meanwhile, n and p may be the same or different from each other.

Among the polysilazanes of General Formula (4), a compound in which R¹, R³, and R⁶ each represents a hydrogen atom and R², R⁴, and R⁵ each represents a methyl group; a compound in which R¹, R³, and R⁶ each represents a hydrogen atom, R² and R⁴ each represents a methyl group, and R⁵ represents a vinyl group; a compound in which R¹, R³, R⁴, and R⁶ each represents a hydrogen atom and R² and R⁵ each represents a methyl group are preferable.

In the above General Formula (5), R¹, R², R³, R⁴, R⁵, R⁶, R⁷, R⁸, and R⁹ represent a hydrogen atom, a substituted or unsubstituted alkyl group, aryl group, vinyl group or (trialkoxysilyl)alkyl group. R¹, R², R³, R⁴, R⁵, R⁶, R⁷, R⁸, and R⁹ each may be the same or different from each other. Since the substituted or unsubstituted alkyl group, aryl group, vinyl group or (trialkoxysilyl)alkyl group are as defined in the above for General Formula (1), no further descriptions are given therefor.

Furthermore, in the above General Formula (5) n, p, and q are an integer and they are preferably determined such that the polysilazane having a structure represented by General Formula (5) has a number average molecular weight of 150 to 150,000 g/mol. Meanwhile, n, p, and q may be the same or different from one another.

Among the polysilazanes of General Formula (5), a compound in which R¹, R³, and R⁶ each represents a hydrogen atom, R², R⁴, R⁵, and R⁸ each represents a methyl group, R⁹ represents a (triethoxysilyl)propyl group, and R⁷ represents an alkyl group or a hydrogen atom is preferable.

Herein, the organo polysilazane in which a part of the hydrogen atoms bonded to Si is substituted with an alkyl group or the like has improved adhesiveness to a substrate as a base by having an alkyl group such as a methyl group, and can provide a ceramic film, which has highly brittleness due to hardness, with toughness of polysilazane. Thus, there is an advantage that an occurrence of cracks is suppressed even when (average) film thickness is increased. As such, perhydropolysilazane and organo polysilazane can be suitably selected depending on use, and they can also be used as a mixture.

The perhydropolysilazane is believed to have a structure in which a linear chain structure and a ring structure having 6- and 8-membered ring as a main ring are present. The molecular weight is about 600 to 2,000 (polystyrene conversion value) in terms of a number average molecular weight (Mn). It is a material of liquid or solid, and the state differs depending on the molecular weight. They are commercially available in a solution state in which they are dissolved in an organic solvent. The commercially available product itself can be used as a polysilazane-containing coating liquid.

Another examples of polysilazane that can be used in the present invention include polysilazane which is ceramized at low temperature such as silicon alkoxide added polysilazane, being produced by reacting silicon alkoxide with polysilazane (JP 5-238827 A); glycidol added polysilazane, being produced by reacting glycidol (JP 6-122852 A); alcohol added polysilazane, being produced by reacting alcohol (JP 6-240208 A); metal carboxylic acid added polysilazane, being produced by reacting metal carboxylate (JP 6-299118 A); acetyl acetonate complex added polysilazane, being produced by reacting acetyl acetonate complex containing a metal (JP 6-306329 A); and metal fine particle added polysilazane, being produced by adding metal fine particles (JP 7-196986 A).

The content of polysilazane in the unmodified layer A according to the present invention can be 100% by weight when the whole amount of the unmodified layer A is 100% by weight. Further, for a case in which the unmodified layer A contains those other than polysilazane, the content of polysilazane in the unmodified layer A is preferably 10% by weight to 99% by weight, more preferably 40% by weight to 95% by weight, and particularly preferably 70% by weight to 95% by weight.

(Forming of Unmodified Layer A)

The unmodified layer A according to the present invention which contains a silicon compound having a polysilazane skeleton can be formed by any method. However, it is preferably produced by wet coating of a coating liquid containing the silicon compound of the formula (1).

Herein, as for the coating method, a suitable wet coating method of a known art can be employed. Specific examples thereof include a spin coating method, a roll coating method, a flow coating method, an inkjet method, a spray coating method, a printing method, a dip coating method, a cast film forming method, a wireless bar coating method, and Gravure method.

Further, as described above, the unmodified layer A may be a laminate of two or more layers. Herein, the method for forming the unmodified layer A for a case in which the unmodified layer A is a laminate of two or more layers is not particularly limited, and it may be a stepwise multilayer coating method or a simultaneous multilayer coating method. Examples of the stepwise multilayer coating method by which coating and drying of each layer is repeated include a roll coating method such as reverse roll coating and Gravure roll coating, blade coating, wire bar coating, and die coating. Furthermore, examples of the simultaneous multilayer coating method include a method in which, by using plural coaters, a next layer is coated before drying of a previously-coated layer and plural layers are simultaneously dried, and a method in which several coating liquids are coated on a slide surface by lamination using slide coating or curtain coating.

Further, the coating liquid can be prepared by dissolving the silicon compound of the formula (1), and if necessary, a catalyst in a solvent. A solvent for preparing the coating liquid is not particularly limited, as long as it can dissolve the silicon compound of the formula (1) (polysilazane). However, an organic solvent not including water and a reactive group which easily reacts with the polysilazane (for example, a hydroxyl group or an amine group) and is inert to the polysilazane is preferable. Aprotic organic solvent is more preferable. Specific examples of the solvent for preparing a coating liquid for forming the polysilazane layer include an aprotic solvent; for example, hydrocarbon solvent such as an aliphatic hydrocarbon, an alicyclic hydrocarbon or an aromatic hydrocarbon such as pentane, hexane, cyclohexane, toluene, xylene, solvesso, or terpene; a halogenated hydrocarbons such as methylene chloride or trichloroethane; esters such as ethyl acetate and butyl acetate; ketones such as acetone and methyl ethyl ketone; ethers such as aliphatic ether and alicyclic ether such as dibutyl ether, dioxane, or tetrahydrofuran, for example, tetrahydrofuran, dibutyl ether, mono- and polyalkylene glycol dialkyl ether (diglymes). The solvent is selected depending on purpose like ability of dissolving polysilazane or evaporation rate of a solvent, or the like. It may be used either singly or as a mixture of two or more types. Although the concentration of silicon compound of the formula (1) (polysilazane) in the coating liquid is not particularly limited and varies in accordance with the film thickness of the gas barrier layer or the pot life of the coating liquid, it is preferably 0.2 to 80% by weight, more preferably 1 to 50% by weight, and particularly preferably 5 to 35% by weight.

In order to promote the modification into silicon oxynitride, a catalyst can be also contained in the coating liquid together with polysilazane. As a catalyst which can be applied for the present invention, a basic catalyst is preferable. In particular, an amine catalyst such as N,N-diethylethanolamine, N,N-dimethylethanolamine, triethanolamine, triethylamine, 3-morpholino propylamine, N,N,N′,N′-tetramethyl-1,3-diaminopropane, or N,N,N′,N′-tetramethyl-1,6-diaminohexanoic acid, a metal catalyst including a Pt compound such as Pt acetylacetonate, a Pd compound such as Pd propionate, and a Rh compound such as Rh acetylacetonate, and an N-heterocyclic compound can be exemplified. Among them, it is preferable to use an amine catalyst. While taking the polysilazane as a reference, a concentration of the catalyst to be added is preferably within a range of 0.1 to 10% by mol, and more preferably within a range of 0.5 to 7% by mol. By having an addition amount of the catalyst within the range, having an excessive forming amount of silanol, a decrease in film density, and an increase in film defects that are caused by a rapid progress of the reaction can be avoided.

Furthermore, if necessary, the following additives can be used in the coating liquid. Examples include cellulose ethers, cellulose esters; for example, ethylcellulose, nitrocellulose, cellulose acetate, and cellulose acetobutylate, natural resins; for example, rubbers and rosin resins, synthetic resins; for example, polymerized resins, condensed resins; for example, aminoplast, in particular, urea resin, melamine formaldehyde resin, alkyd resin, acrylic resin, polyester or modified polyester, epoxide, polyisocyanate, or blocked polyisocyanate, and polysiloxane.

By using the aforementioned coating liquid, a gas barrier layer of glass type which has no cracks and holes and has an excellent barrier property against gas can be manufactured.

The thickness (film thickness) of the unmodified layer A is not particularly limited, and it can be suitably determined according to the desired thickness (dry film thickness) of the gas barrier layer. For example, the thickness (film thickness) of the unmodified layer A is preferably 1 nm to 100 μm or so, more preferably 10 nm to 10 μm or so, even more preferably 50 nm to 1 μm, and particularly preferably 100 to 500 nm or so in terms of thickness after drying (dry film thickness). When the film thickness of the unmodified layer A is 1 nm or more, a sufficient barrier property (for example, low oxygen transmission property and low water vapor transmission property) can be obtained. When it is 100 μm or less, a stable coating property can be obtained during forming of a gas barrier layer, and also high light transmittance can be achieved. Meanwhile, when the unmodified layer A is laminated, it is preferable that the thickness of the whole unmodified layer A has a thickness described above.

As described herein, the thickness (dry film thickness) of a layer (including the unmodified layer A, the layer B, and the modified layer A) is measured by performing TEM observation of a cross-section of a thin specimen, which is prepared from each sample by a FIB processing device described below. Furthermore, regarding the presence or absence of a modification of a layer (including the unmodified layer A, the layer B, and the modified layer A), when a thin specimen is prepared by using the FIB processing device described below and then continuously irradiated with electron beam, a difference in contrast is exhibited between a part having damages caused by electron beam and a part having no such damages. In this case, a part treated with a modification treatment has a dense structure so that it is unlikely to have damages caused by electron beam. On the other hand, a part not treated with a modification treatment has damages caused by electron beam, and thus deterioration is determined therefrom. According to this TEM observation allowing the determination, calculation of film thickness for the modified part and unmodified part can be also made.

[Chemical Formula 6]

### (FIB Processing)

Apparatus: SMI2050 manufactured by SII

### Processing ion: (Ga 30 kV)

Sample thickness: 100 nm to 200 nm (TEM observation)
Apparatus: JEM2000FX manufactured by JEOL Ltd.
(acceleration voltage: 200 kV)
Time for electron beam irradiation: 5 seconds to 60 seconds

After the above coating, the unmodified layer A can be formed by drying the coating film. However, it is preferably performed under the conditions at which the unmodified layer A is not completely solidified. The drying conditions are not particularly limited, and they may vary depending on composition of a coating liquid and film thickness. Specifically, there is a method of drying for 1 second to 30 minutes using dry air having dew point of −50° C. to 10° C.

[Step (b)]

According to Step (b), the layer B which contains a compound having an oxygen element or a nitrogen element (O/N containing compound) is formed on top of the unmodified layer A formed in Step (a).

(Layer B)

The layer B contains a compound having an oxygen element or a nitrogen element (O/N containing compound). Herein, the layer B may contain only one type of O/N containing compound or two or more types of O/N containing compound. Furthermore, with regard to the layer B, only a single layer may be formed or two or more layers are laminated on top of the unmodified layer A.

The present invention is characterized in that the unmodified layer A is modified via the layer B. As such, it is preferable that the compound for constituting the layer B is less likely to be modified by VUV ray compared to the silicon compound of the formula (1) for constituting the unmodified layer A. As such, it is preferable that the unmodified layer A and the layer B have a different composition. The expression “the unmodified layer A and the layer B have a different composition” means that it is not necessary for the unmodified layer A and the layer B to be constituted with completely different materials, but as long as they have a different composition, part of the materials for constituting the unmodified layer A and the layer B can be overlapped. By selecting a material which is hardly modified by VUV ray as a compound for constituting the layer B, energy of the VUV ray is not consumed for the modification of the layer B and the unmodified layer A can be efficiently modified by it.

The compound having an oxygen element or a nitrogen element (O/N containing compound) is not particularly limited if it is a compound having at least one of an oxygen element or a nitrogen element. Specifically, preferred examples thereof include metal oxide, alkoxide of an alkali metal, a metal compound having a constitutional unit represented by the following General Formula (2):

[Chemical Formula 7]

R⁵-[M(R⁴)ₘ₁—Yₘ₂]ₙ—R⁶ General Formula (2)

a primary amine compound, a secondary amine compound, a tertiary amine compound, and a diamine compound represented by the following General Formula (3):

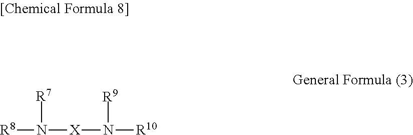

The O/N containing compound may be used either singly or as a mixture of two or more types thereof.

Among them, the O/N containing compound preferably contains at least an O atom. According to modification of the unmodified layer A via the layer B which is formed of a compound containing an O atom, it becomes possible to form a gas barrier layer which has few dangling bonds and high O compositional ratio.

(Metal Oxide)

Examples of the metal oxide which can be used as an O/N containing compound include, although not particularly limited, silicon oxide (silica), aluminum oxide (alumina), titan oxide (titania), zirconium oxide (zirconia), zinc oxide, and cerium oxide. Among them, from the viewpoint of transmission property for VUV ray or the like, silicon oxide and aluminum oxide are preferable, and silicon oxide is more preferable.

Shape of the metal oxide is, although not particularly limited, preferably a particulate shape. In this case, the average particle diameter of the meal oxide is preferably 0.1 to 300 nm or so, and preferably 1 to 100 nm or so, although not particularly limited thereto. With such size, it can efficiently transmit VUV ray and efficiently modify the unmodified layer A. Furthermore, a smooth film can be produced. Meanwhile, the “average particle diameter” described herein can be measured based on average value of crystallite diameter obtained from half width value of a diffraction peak of the catalyst component according to X ray diffraction or particle diameter of a catalyst component which is determined from the transmission type electron microscopic image.

(Alkoxide of Alkali Metal)

The alkoxide of an alkali metal which can be used as an O/N containing compound is not particularly limited, but an alkali metal to which an alkoxy group with 1 to 10 carbon atoms is bonded is preferable. Specific examples thereof include sodium methoxide, sodium ethoxide, sodium propoxide, sodium isopropoxide, sodium butoxide, potassium methoxide, potassium ethoxide, potassium propoxide, potassium isopropoxide, potassium butoxide, cesium methoxide, cesium ethoxide, cesium propoxide, cesium isopropoxide, and cesium butoxide.

(Metal Compound Having Structural Unit Represented by General Formula (2))

As the O/N containing compound, a metal compound having a structural unit represented by General Formula (2) can be used. As described herein, the metal compound “has a structural unit represented by General Formula (2)” means that it has a structural unit of General Formula (2) in a part of the compound, and examples thereof include silsesquioxane represented by General Formula [RSiO_{1.5}] such as perhydrosilsesquioxane.

[Chemical Formula 9]

R⁵-[M(R⁴)ₘ₁—Yₘ₂]ₙ—R⁶ General Formula (2)

In the above General Formula (2), M represents barium (Ba), magnesium (Mg), silicon (Si), aluminum (Al), boron (B), iron (Fe), cobalt (Co), titan (Ti), zirconium (Zr), nickel (Ni), copper (Cu), zinc (Zn), indium (In), chrome (Cr), manganese (Mn), ruthenium (Ru), rhodium (Rh), palladium (Pd), iridium (Ir), or platinum (Pt). Herein, when n is 2 or more (there are more than one -[M(R⁴)ₘ]—), M in each -[M(R⁴)ₘ]— unit may be the same or different from each other. Among them, from the viewpoint of transmission property for VUV ray, reactivity with polysilazane or the like, M is preferably silicon (Si), aluminum (Al), or boron (B). In particular, when M is silicon, more strong adhesiveness between the unmodified layer A or the modified layer A and the layer B is obtained, and thus it is particularly preferable.

Furthermore, Y represents a single bond or an oxygen atom (—O—).

R⁴, R⁵, and R⁶ represent a hydrogen atom, a halogen atom, a cyano group (—CN), a nitro group (—NO₂), a mercapto group (—SH), an epoxy group (oxacyclopropyl group as a three-membered cyclic ether), a hydroxyl group (—OH), a substituted or unsubstituted alkyl group with 1 to 10 carbon atoms, a substituted or unsubstituted cycloalkyl group with 3 to 10 carbon atoms, a substituted or unsubstituted alkenyl group with 2 to 10 carbon atoms, a substituted or unsubstituted alkynyl group with 2 to 10 carbon atoms, a substituted or unsubstituted alkoxy group with 1 to 10 carbon atoms, an acetylacetonate group (—O—C(CH₃)═CH—C(═O)—CH₃), a substituted or unsubstituted (alkyl)acetoacetate group with 4 to 25 carbon atoms, a substituted or unsubstituted aryl group with 6 to 30 carbon atoms, a substituted or unsubstituted heterocyclic group or an amino group (—NH₂). Herein, R⁴, R⁵, and R⁶ each may be the same or different from each other. Furthermore, when n is 2 or more (there are more than one -[M(R⁴)ₘ]—), each R⁴ in each -[M(R⁴)ₘ]— unit may be the same or different from each other.

Herein, as for the halogen atom, any one of fluorine atom, chlorine atom, bromine atom, and iodine atom can be used.

The alkyl group with 1 to 10 carbon atoms is not particularly limited, and it is a linear or branched alkyl group with 1 to 10 carbon atoms. Examples thereof include a methyl group, an ethyl group, a propyl group, an isopropyl group, an n-butyl group, an isobutyl group, a sec-butyl group, a tert-butyl group, a pentyl group, an isopentyl group, a neopentyl group, a hexyl group, a heptyl group, an octyl group, a nonyl group, a decyl group, and a 2-ethylhexyl group. Among them, from the viewpoint of transmission property for VUV ray, density of a film, or the like, a linear or branched alkyl group with 1 to 6 carbon atoms is preferable, and a linear or branched alkyl group with 1 to 5 carbon atoms is more preferable.

The cycloalkyl group with 3 to 10 carbon atoms is not particularly limited, but examples thereof include a cyclopropyl group, a cyclobutyl group, a cyclopentyl group, a cyclohexyl group, a cycloheptyl group, and a cyclooctyl group.

The alkenyl group with 2 to 10 carbon atoms is not particularly limited, and it is a linear or branched alkenyl group with 2 to 10 carbon atoms. Examples thereof include a vinyl group, an allyl group, a 1-propenyl group, an isopropenyl group, a 1-butenyl group, a 2-butenyl group, a 3-butenyl group, a 1-pentenyl group, a 2-pentenyl group, a 3-pentenyl group, a 1-hexenyl group, a 2-hexenyl group, a 3-hexenyl group, a 1-heptenyl group, a 2-heptenyl group, a 5-heptenyl group, a 1-octenyl group, a 3-octenyl group, and a 5-octenyl group.

The alkynyl group with 2 to 10 carbon atoms is not particularly limited, and it is a linear or branched alkynyl group with 2 to 10 carbon atoms. Examples thereof include an acetylenyl group, a 1-propynyl group, a 2-propynyl group, a 1-butynyl group, a 2-butynyl group, a 3-butynyl group, a 1-pentynyl group, a 2-pentynyl group, a 3-pentynyl group, a 1-hexynyl group, a 2-hexynyl group, a 3-hexynyl group, a 1-heptynyl group, a 2-heptynyl group, a 5-heptynyl group, a 1-octynyl group, a 3-octynyl group, and a 5-octynyl group.

The alkoxy group with 1 to 10 carbon atoms is not particularly limited, and it is a linear or branched alkoxy group with 1 to 10 carbon atoms. Examples thereof include a methoxy group, an ethoxy group, a propoxy group, an isopropoxy group, an n-butoxy group, a sec-butoxy group, a tert-butoxy group, a pentyloxy group, a hexyloxy group, a 2-ethylhexyloxy group, an octyloxy group, a nonyloxy group, and a decyloxy group. Among them, from the viewpoint of transmission property for VUV ray, reactivity with polysilazane, density of a film, or the like, a linear or branched alkoxy group with 1 to 8 carbon atoms is preferable, and a linear or branched alkoxy group with 1 to 5 carbon atoms is more preferable.

The (alkyl)acetoacetate group with 4 to 25 carbon atoms is not particularly limited, and it represents a hydrogen atom, an acetoacetate group to which a linear or branched alkoxy group with 1 to 6 carbon atoms is bonded. Examples thereof include an acetoacetate group (—O—C(CH₃)═CH—C(═O)—OH), a methylacetoacetate group (—O—C(CH₃)═CH—C(═O)—C—O—CH₃), an ethylacetoacetate group (—O—C(CH₃)═CHC(═O)—C—O—C₂H₅), a propylacetoacetate group, an isopropylacetoacetate group, and an octadecylacetoacetate group. Among them, from the viewpoint of transmission property for VUV ray, reactivity with polysilazane, density of a film, or the like, an ethylacetoacetate group, a methylacetoacetate group, and an acetoacetate group are preferable.

The aryl group with 6 to 30 carbon atoms is not particular limited, and examples thereof include a phenyl group, a naphthyl group, a biphenyl group, a fluorenyl group, an anthryl group, a pyrenyl group, an azulenyl group, an acenaphthylenyl group, a terphenyl group, and a phenanthryl group.

Examples of the heterocyclic group include, although not particularly limited, a thiophene ring, a dithienothiophene ring, a cyclopentadithiophene ring, a phenylthiophene ring, a diphenylthiophene ring, an imidazole ring, an oxazole ring, an isoxazole ring, a thiazole ring, a pyrrole ring, a furan ring, a benzofuran ring, an isobenzofuran ring, a coumarin ring (for example, 3,4-dihydrocoumarin), a benzimidazole ring, a benaoxazole ring, a rhodanine ring, a pyrazolone ring, an imidazolone ring, a pyran ring, a pyridine ring, a pyrazine ring, a pyrazole ring, a pyrimidine ring, a pyridazine ring, a triazine ring, a flurorene ring, a benzothiephene ring, a benzo (c)thiophene ring, a benzimidazole ring, a benzoxazole ring, a benzisoxazole ring, a benzothiazole ring, an indole ring, a phthalazine ring, a cinnanoline ring, a quinazoline ring, a carbazole ring, a carboin ring, a diazacarboin ring (carboin in which any carbon atom is substituted with a nitrogen atom), 1,10-phenanthroline ring, a quinone ring, a rhodanine ring, a dirhodanine ring, a thiohydantoin ring, a pyrazolone ring, or a group derived from a pyrazoline ring.

Furthermore, the substituent group which is present on the above R⁴, R⁵, and R⁶ depending on a case is not particularly limited, but examples thereof include a halogen atom (fluorine atom, chlorine atom, bromine atom, and iodine atom), a linear or branched alkyl group with 1 to 24 carbon atoms, a cycloalkyl group with 3 to 24 carbon atoms (for example, a cyclopentyl group, a cyclohexyl group), a hydroxyalkyl group with 1 to 24 carbon atoms (for example, a hydroxymethyl group, a hydroxyethyl group), an alkoxyalkyl group with 2 to 24 carbon atoms (for example, a methoxyethyl group), an alkoxy group with 1 to 24 carbon atoms (for example, a methoxy group, an ethoxy group, a propoxy group, an isopropoxy group, a butoxy group, a pentyloxy group, a hexyloxy group, a 2-ethylhexyloxy group, an octyloxy group, a dodecyloxy group), a cycloalkoxy group with 3 to 24 carbon atoms (for example, a cyclopentyloxy group, a cyclohexyloxy group), an alknenyl group, an alkynyl group, an amino group, an aryl group, an aryloxy group with 6 to 24 carbon atoms (for example, a phenoxy group, a naphthyloxy group), an alkylthio group with 1 to 24 carbon atoms (for example, a methylthio group, an ethylthio group, a propylthio group, a pentylthio group, a hexylthio group, an octylthio group, a dodecylthio group), a cycloalkylthio group with 3 to 24 carbon atoms (for example, a cyclopentylthio group, a cyclohexylthio group), an arylthio group with 6 to 24 carbon atoms (for example, a phenylthio group, a naphthylthio group), an alkoxycarbonyl group with 1 to 24 carbon atoms (for example, a methyloxycarbonyl group, an ethyloxycarbonyl group, a butyloxycarbonyl group, an octyloxycarbonyl group, a dodecyloxycarbonyl group), an aryloxycarbonyl group with 7 to 24 carbon atoms (for example, a phenyloxycarbonyl group, a naphthyloxycarbonyl group), a hydroxyl group (—OH), a carboxy group (—COOH), a thiol group (—SH), and a cyano group (—CN). Meanwhile, as the alkyl group, alkenyl group, alkynyl group, amino group, and aryl group have the same definitions as described above, no further explanations are given therefor. Furthermore, the number of the substituent group is not particularly limited, and it can be suitably selected considering the desired effect (transmission property for VUV ray, solubility, reactivity with polysilazane, or the like). Regarding the descriptions described above, there is no case in which substitution is made with the same substituent group. In other words, a substituted alkyl group is not substituted with an alkyl group.

Among them, it is preferable that at least one of R⁴, R⁵, and R⁶ represents a hydroxyl group, an alkyl group with 1 to 10 carbon atoms, or an alkoxy group with 1 to 10 carbon atoms. A compound containing an alkoxy group or a hydroxyl group has a high effect of promoting the conversion reaction because the bond in an alkoxy group part or a hydroxyl group part can be easily open by VUV ray and the open alkoxy group part or hydroxyl group part rapidly reacts with polysilazane. Furthermore, a compound containing an alkyl group allows forming of a film provided with plasticity. Furthermore, at least one of R⁴, R⁵, and R⁶ is preferably an alkyl group with 1 to 10 carbon atoms, an alkoxy group with 1 to 10 carbon atoms, or an (alkyl)acetoacetate with 4 to 25 carbon atoms. It is more preferably an alkyl group with 1 to 10 carbon atoms or an alkoxy group with 1 to 10 carbon atoms. It is particularly preferably an alkyl group with 1 to 10 carbon atoms.

In the above General Formula (2), m1 and m2 are an integer of 1 or more, m1+m2 is an integer which is determined by M and it is generally determined based on the number of bonding arm of M. Herein, m1 and m2 may be the same integer or a different integer. n is an integer of 1 or more, and from the viewpoint of the transmission property for VUV ray, density of a film, or the like, it is preferably an integer of 1 to 10, and more preferably 1 to 4.

Examples of the metal compound represented by the above General Formula (2) include aluminum isopropoxide, aluminum sec-butyrate, titan isopropoxide, methyl.hydropolysiloxane, organopolysiloxane, trimethyl borate, triethyl borate, tri(tert-butyl)borate, triisopropyl borate, tributyl borate, aluminum triethylate, aluminum triisopropylate, aluminum tri tert-butyrate, aluminum tri n-butyrate, aluminum tri sec-butyrate, aluminum ethylacetoacetate.diisopropylate, acetoalkoxyaluminum diisopropylate, barium isopropylate, titan (IV) isopropylate, zirconium tetraacetylacetonate, aluminum diisopropylate monoaluminum t-butyrate, aluminum trisethylacetoacetate, aluminum oxide isopropoxide trimer, zirconium (IV) isopropylate, tris(2,4-pentanedionato) titanium (V), tetrakis(2,4-pentanedionato) zirconium (IV), tris(2,4-pentanedionato) cobalt (III), tris(2,4-pentanedionato) iron (III), tris(2,4-pentanedionato) ruthenium (III), bis(2,4-pentanedionato) palladium (II), tris(2,4-pentanedionato) iridium (III), tris(2,4-pentanedionato)aluminum (III), tris(2,4-pentanedionato) rhodium (III), bis(2,4-pentanedionato) platinum (II), bis(2,4-pentanedionato) nickel (II), bis(2,4-pentanedionato) copper (II), bis(2,4-pentanedionato) zinc (II), tris(2,4-pentanedionato) manganese (III), tris(2,4-pentanedionato) chrome (III), tris(2,4-pentanedionato) indium (III), tris(2,4-pentanedionato) barium (III), magnesium ethoxide, sodium ethoxide, and a metal compound having the following structure

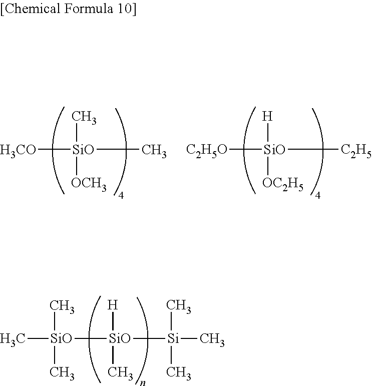

wherein n is an integer of 1 to 10.

Among them, from the viewpoint of the transmission property for VUV ray or the like, aluminum ethylacetoacetate-diisopropylate, triisopropyl borate, tri(tert-butyl)borate, aluminum sec-butyrate, and a compound having the above structure are preferable.

Furthermore, as described above, as a compound having a structural unit represented by General Formula (2), silsesquioxane represented by the general formula [RSiO_{1.5}] can be mentioned.

Silsesquioxane is a siloxane-based compound having a main skeleton consisting of a Si—O bond. Silsesquioxane (also referred to as polysilsesquioxane) is also referred to as T resin and is a compound which is represented by general formula [RSiO_{1.5}] while common silica is represented by [SiO₂]. Generally, it is polysiloxane synthesized by hydrolysis-polycondensation of (RSi(OR′)₃) compound in which one alkoxy group of tetraalkoxysilane (Si(OR′)₄) represented by tetraethoxysilane is substituted with an alkyl group or an aryl group, and representative examples of the molecular arrangement include amorphous shape, ladder shape, and basket shape (fully condensed cage shape).

Silsesquioxane can be synthesized or a commercially available product can be used. Specific examples of the latter include X-40-2308, X-40-9238, X-40-9225, X-40-9227, x-40-9246, KR-500, KR-510 (all manufactured by Shin-Etsu Chemical Co., Ltd.), SR2400, SR2402, SR2405, FOX14 (perhydrosilsesquioxane) (all manufactured by Dow Corning Toray Co., Ltd.), and SST-H8H01 (perhydrosilsesquioxane) (manufactured by Gelest).

(Amine Compound)

As the O/N containing compound, an amine compound (primary amine compound, secondary amine compound, and tertiary amine compound) can be used. Herein, the primary amine compound is represented by the formula: NH₂R. The secondary amine compound is represented by the formula: NHR₂. The tertiary amine compound is represented by the formula: NR₃. In the above formulae, R represents a substituted or unsubstituted alkyl group having 1 to 10 carbon atoms. Herein, the “substituted or unsubstituted alkyl group having 1 to 10 carbon atoms” is as defined in the above for General Formula (2), and thus no further explanations are given therefor. Examples of the amine compound include a primary amine compound such as methylamine, ethylamine, propylamine, n-butylamine, sec-butylamine, or ter-butylamine; a secondary amine compound such as dimethylamine, diethylamine, methylethylamine, dipropylamine, di(n-butyl)amine, di(sec-butyl)amine, or di(ter-butyl)amine; and a tertiary amine compound such as trimethylamine, triethylamine, dimethylethylamine, methyldiethylamine, tripropylamine, tri(n-butyl)amine, tri(sec-butyl)amine, or tri(ter-butyl)amine.

(Diamine Compound Represented by General Formula (3))

As the O/N containing compound, a diamine compound represented by the following General Formula (3) can be used.

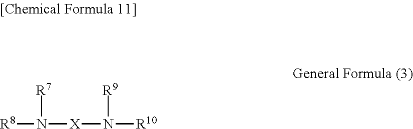

In the above General Formula (3), R⁷ to R¹⁰ represent a substituted or unsubstituted alkyl group with 1 to 10 carbon atoms, a substituted or unsubstituted cycloalkyl group with 3 to 10 carbon atoms, a substituted or unsubstituted alkenyl group with 2 to 10 carbon atoms, a substituted or unsubstituted alkynyl group with 2 to 10 carbon atoms, a substituted or unsubstituted alkoxy group with 1 to 10 carbon atoms, a substituted or unsubstituted aryl group with 6 to 30 carbon atoms, or a substituted or unsubstituted heterocyclic group. Herein, R⁷ to R¹⁰ each may be the same or different from each other. Herein, “a substituted or unsubstituted alkyl group with 1 to 10 carbon atoms”, “a substituted or unsubstituted cycloalkyl group with 3 to 10 carbon atoms”, “a substituted or unsubstituted alkenyl group with 2 to 10 carbon atoms”, “a substituted or unsubstituted alkynyl group with 2 to 10 carbon atoms”, “a substituted or unsubstituted alkoxy group with 1 to 10 carbon atoms”, “a substituted or unsubstituted aryl group with 6 to 30 carbon atoms”, and “a substituted or unsubstituted heterocyclic group” are as defined in the above for General Formula (2), and thus no further explanations are given therefor.

In the above General Formula (3), X represents a substituted or unsubstituted alkylene group with 1 to 10 carbon atoms, or an imino group (—C(═NH)—). Herein, the alkylene group with 1 to 10 carbon atoms is a linear or branched alkylene group with 1 to 10 carbon atoms and examples thereof include a methylene group, an ethylene group, a trimethylene group, a tetramethylene group, a propylene group, a pentamethylene group, a hexamethylene group, a heptamethylene group, and an octamethylene group. Among them, from the viewpoint of transmission property for VUV ray or the like, a linear or branched alkyl group with 1 to 8 carbon atoms is preferable, and a linear or branched alkyl group with 1 to 6 carbon atoms is more preferable. Furthermore, the substituent group in a case where X represents a substituted alkylene group with 1 to 10 carbon atoms is not particularly limited, and because it is as defined in the above for General Formula (2), no further explanations are given therefor.

Specific examples of the diamine compound represented by General Formula (3) include tetramethylmethane diamine, tetramethylethane diamine, tetramethylpropane diamine(tetramethyldiaminopropane), tetramethylbutane diamine, tetramethylpentane diamine, tetramethylhexane diamine, tetraethylmethane diamine, tetraethylethane diamine, tetraethylpropane diamine, tetraethylbutane diamine, tetraethylpentane diamine, tetraethylhexane diamine, and tetramethylguanidine. Among them, from the viewpoint of transmission property for VUV ray or the like, tetramethylpropane diamine(tetramethyldiaminopropane) is preferable.

Among the aforementioned O/N containing compounds, from the viewpoint of transmission property for VUV ray, reactivity with polysilazane or the like, silicon oxide, perhydrosilsesquioxane, and a metal compound having a constitutional unit represented by General Formula (2) in which M is silicon (Si), aluminum (Al), or boron (B), and at least one of R⁴, R⁵, and R⁶ is an alkyl group with 1 to 10 carbon atoms or an alkoxy group with 1 to 10 carbon atoms are preferable. More preferably, the O/N containing compound is, from the viewpoint of further improvement of transmission property for VUV ray or the like, silicon oxide, perhydrosilsesquioxane, or a metal compound represented by General Formula (2) in which M is silicon (Si) or aluminum (Al) and at least one of R⁴, R⁵, and R⁶ is an alkoxy group with 1 to 10 carbon atoms.

The O/N containing compound can be synthesized or a commercially available product can be used.

The layer B of the present invention preferably consists of the O/N containing compound (content of the O/N containing compound is 100% by weight when the total weight of the layer B is 100% by weight). However, it may contain other compound in addition to the aforementioned O/N containing compound. In that case, the content of the O/N containing compound in the layer B is preferably 10% by weight to 99% by weight, more preferably 40% by weight to 95% by weight, and particularly preferably 70% by weight to 95% by weight in terms of the content of the O/N containing compound in the layer B.

(Forming of Layer B)

The layer B containing the O/N containing compound can be formed on top of the unmodified layer A by any method. However, it is preferably produced by wet coating of a coating liquid containing the O/N containing compound on top of the unmodified layer A.

Herein, as for the coating method, a suitable wet coating method of a known art can be employed. Specific examples thereof include a spin coating method, a roll coating method, a flow coating method, an inkjet method, a spray coating method, a printing method, a dip coating method, a cast film forming method, a bar coating method, and Gravure method.

Further, as described above, the layer B may be a laminate of two or more layers. Herein, the method for forming the layer B for a case in which the unmodified layer B is a laminate of two or more layers is not particularly limited, and it may be a stepwise multilayer coating method or a simultaneous multilayer coating method. Examples of the stepwise multilayer coating method by which coating and drying of each layer is repeated include a roll coating method such as reverse roll coating and Gravure roll coating, blade coating, wire bar coating, and die coating. Furthermore, examples of the simultaneous multilayer coating method include a method in which, by using plural coaters, a next layer is coated before drying of a previously-coated layer and several layers are simultaneously dried, and a method in which plural coating liquids are coated on a single side by lamination using slide coating or curtain coating.

Further, the coating liquid can be prepared by dissolving the O/N containing compound, and if necessary, a catalyst in a solvent. A solvent for preparing the coating liquid is not particularly limited, as long as it can dissolve the O/N containing compound. However, an organic solvent not including water and a reactive group which easily reacts with the O/N containing compound (for example, a hydroxyl group or an amine group) and is inert to the O/N containing compound is preferable. Aprotic organic solvent is more preferable. Specific examples of the solvent for preparing a coating liquid for forming the layer B include an aprotic solvent; for example, hydrocarbon solvent such as an aliphatic hydrocarbon, an alicyclic hydrocarbon or an aromatic hydrocarbon such as pentane, hexane, cyclohexane, toluene, xylene, solvesso, or terpene; a halogenated hydrocarbons such as methylene chloride or trichloroethane; esters such as ethyl acetate and butyl acetate; ketones such as acetone, methyl ethyl ketone (MEK), and methyl isobutyl ketone; ethers such as aliphatic ether and alicyclic ether such as dibutyl ether, dioxane, or tetrahydrofuran, for example, tetrahydrofuran, dibutyl ether, mono- and polyalkylene glycol dialkyl ether (diglymes). The solvent is selected depending on purpose like ability of dissolving polysilazane or evaporation rate of a solvent, or the like. It may be used either singly or as a mixture of two or more types. Although the concentration of the O/N containing compound in the coating liquid is not particularly limited and varies in accordance with the film thickness of the gas barrier layer or the pot life of the coating liquid, it is preferably 0.2 to 80% by weight, more preferably 1 to 50% by weight, and particularly preferably 5 to 35% by weight.

If necessary, the following additives can be used in the coating liquid. Examples include cellulose ethers, cellulose esters; for example, ethylcellulose, nitrocellulose, cellulose acetate, and cellulose acetobutyrate, natural resins; for example, rubbers and rosin resins, synthetic resins; for example, polymerized resins, condensed resins; for example, aminoplast, in particular, urea resin, melamine formaldehyde resin, alkyd resin, acrylic resin, polyester or modified polyester, epoxide, polyisocyanate, or blocked polyisocyanate, and polysiloxane.

Alternatively, the silicon compound of the formula (1) can be contained in the coating liquid. In that case, because the layer B is also subjected to a modification treatment according to Step (c) described below, the gas barrier property (for example, water vapor transmission property) can be improved more. Meanwhile, in that case, the unmodified layer A and the layer B have different composition, and it is preferable that the content of the silicon compound of the formula (1) in the layer B is lower than the content of the silicon compound of the formula (1) in the unmodified layer A. It is more preferable that the content of the silicon compound of the formula (1) in the layer B is ⅕ to 1/100 or so of the content of the silicon compound of the formula (1) in the unmodified layer A. Accordingly, the modification of the unmodified layer A can be performed efficiently.

The thickness (coating thickness) of the layer B is not particularly limited, and it can be suitably determined according to the desired thickness (dry film thickness) of the unmodified layer A or desired degree of the modification. The thickness (coating thickness) of the layer B also varies depending on the amount of oxygen or nitrogen atoms that are present in the O/N containing compound. In other words, when there is a great amount of oxygen or nitrogen atoms present in the O/N containing compound, the reaction of radical species that are generated inside the layer A can be more efficiently promoted, and thus the layer B can be relatively thin. The thickness (coating thickness) of the layer B is preferably 3 to 700 nm or so, more preferably 10 to 500 nm or so, and particularly preferably 30 to 300 nm or so in terms of thickness after drying (dry film thickness). When the film thickness of the layer B is the same or greater than the lower limit, a sufficient amount of O element source or N element source is supplied to the unmodified layer A during VUV irradiation, and an efficient reaction between radical species that are generated according to breaking of atomic bonds in the unmodified layer A and the O element source or N element source can be obtained. As such, the unmodified layer A can be modified sufficiently and uniformly in the thickness direction. Furthermore, when the film thickness is the same or smaller than the upper limit, a sufficient amount of VUV ray passes through the layer B to reach the unmodified layer A, and thus the unmodified layer A can be modified sufficiently and uniformly in the thickness direction. Meanwhile, for a case in which the layer B is laminated, it is preferable that the thickness of the whole layer B has the thickness described above.

After the above coating, the layer B can be formed by drying the coating film. However, it is preferably performed under the conditions at which the layer B is not completely solidified. The drying conditions are not particularly limited, and they may vary depending on composition of a coating liquid and film thickness. Specifically, there is a method of drying for 1 second to 30 minutes using dry air having dew point of −50° C. to 10° C.

In the above, the unmodified layer A and the layer B are formed in order (separately). However, in the present invention, both the unmodified layer A and the layer B can be formed simultaneously on a substrate. Namely, according to the process of the present invention, the unmodified layer A and the layer B can be formed on a substrate by a simultaneous multilayer coating method. Herein, examples of the simultaneous multilayer coating method include a method in which, by using plural coaters, a next layer is coated before drying of a previously-coated layer and several layers are simultaneously dried, and a method in which several coating liquids are coated on a slide surface by lamination using slide coating or curtain coating. In that case, as for the conditions other than those for forming the unmodified layer A and the layer B simultaneously on a substrate, for example, the coating liquid for forming both the unmodified layer A and the layer B, thickness of each layer (dry film thickness), or the like, the same conditions as those described above for forming the unmodified layer A and forming the layer B can be applied.

[Step (c)]

According to Step (c), vacuum ultraviolet ray is irradiated from above the layer B through the layer B side, which has been formed during Step (b) above, to modify the unmodified layer A. Because ozone or active oxygen atom produced by vacuum ultraviolet ray (same meaning as vacuum ultraviolet light) has a high oxidizing ability, it allows forming of a silicon oxide film or a silicon oxynitride film which has high density and insulating property at low temperature. Herein, the vacuum ultraviolet ray irradiation can be performed only once or repeatedly performed, that is, two or more times. However, the unmodified layer A is not subjected to VUV irradiation before Step (c).

According to Step (c), modification of the unmodified layer A (silicon compound) is performed via the layer B containing an oxygen element source or a nitrogen element source, and as the layer B melts according to VUV irradiation, mixing of constitutional compound of each layer occurs at an interface between the unmodified layer A (the polysilazane layer) and the layer B. Accordingly, a state in which the polysilazane concentration is lower at an interface between the unmodified layer A and the layer B compared to the inside of the layer A is yielded. As such, a difference in modification speed between the surface and the inside of the polysilazane layer becomes smaller. Furthermore, as the layer B contains an oxygen element source or a nitrogen element source, the reaction of radical species that are generated inside the layer A can be promoted. Accordingly, the modified layer A can provide a gas barrier layer which has few dangling bonds and a little change in composition under high temperature and high moisture conditions.

As O₂ and H₂O which contribute to ceramization (silica conversion), or an ultraviolet ray absorbing agent, polysilazane itself are excited and activated by VUV irradiation, the polysilazane is excited, ceramization of polysilazane is promoted, and a more dense ceramic layer is obtained therefrom. In the present invention, irradiation with vacuum ultraviolet ray (VUV) is essential for Step (c) and, in addition to the irradiation with vacuum ultraviolet ray (VUV), ultraviolet ray of other wavelength, for example ultraviolet ray of 210 to 350 nm can be further irradiated.

In the present invention, the “vacuum ultraviolet ray (VUV)” indicates electronic wave having wavelength of 10 to 200 nm, and preferably electronic wave having wavelength of 100 to 200 nm. For the treatment based on vacuum ultraviolet ray irradiation, a silicon oxynitride film can be formed at relatively low temperature by allowing an oxidization reaction by active oxygen or ozone to proceed while directly dissociating the bond of atoms by the action of only photons, which is called a light quantum process, using light energy of 100 to 200 nm, which is greater than an interatomic bonding force within a polysilazane compound, preferably using energy of light having a wavelength of 100 to 180 nm.

A vacuum ultraviolet irradiation source required therefor is not particularly limited, and a radiation source such as a rare gas excimer lamp (for example, a Xe₂* excimer lamp) having the maximum radiation at about 172 nm, a low-pressure mercury vapor lamp having an emission line at about 185 nm, or the like can be used. In the presence of oxygen and/or water vapor, ozone, oxygen radical, and hydroxyl radical are generated with high efficiency according to photodegradation caused by high light absorption coefficient of those gases in the aforementioned wavelength range, and they promote oxidation of the polysilazane layer. Those two working systems, that is, degradation of Si—N bond and the action of ozone, oxygen radical, and hydroxyl radical, can occur only after ultraviolet ray reaches the surface of the polysilazane layer.

Herein, the presumed mechanism for modification of a coating film containing polysilazane and having specific composition of SiOₓN_{y} by the vacuum ultraviolet ray irradiation step is described by having perhydropolysilazane as an example.

Perhydropolysilazane can be expressed by the composition of “—(SiH₂—NH)ₙ-”. When it is expressed as SiOₓN_{y}, x=0, y=1. To have x>0, an external oxygen source is required. In this regard, the oxygen source can be (i) oxygen or moisture contained in a polysilazane coating liquid, (ii) oxygen or moisture introduced from atmosphere to the coating film during the step for drying the coating, (iii) oxygen, moisture, or singlet oxygen introduced from atmosphere to the coating film during the step of vacuum ultraviolet ray irradiation, (iv) oxygen or moisture transferred as out gas from a substrate side to the coating film as caused by heat applied during the step of vacuum ultraviolet ray irradiation, or (v) oxygen or moisture introduced from atmosphere to the coating film during shift from a non-oxidizing atmosphere to an oxidizing atmosphere when the step of vacuum ultraviolet ray irradiation is performed in a non-oxidizing atmosphere.

Furthermore, based the relationship among bonding arms of Si, O, and N, x and y are basically in the relationship of 2x+3y≦4. In a completely oxidized state in which y=0, a silanol group is contained in the coating film, and it may have a range of 2<x<2.5

Next, explanations are given for a reaction mechanism which is believed to be involved with generation of silicon oxynitride, and further silicon oxide from perhydropolysilazane during a vacuum ultraviolet ray irradiation process.

(I) Dehydrogenation and Forming of Si—N Bond Accompanied Therewith

It is believed that Si—H bond or N—H bond in perhydropolysilazane is relatively easily broken by excitation or the like by vacuum ultraviolet ray irradiation and binds again as Si—N under an inert atmosphere (non-bonding arm of Si may be also formed). That is, it is cured as SiN_{y} composition without oxidation, and thus breakage of a polymer main chain does not occur. Breakage of Si—H bond or N—H bond is promoted by presence of a catalyst or by heating. Broken H is released as H₂ to an outside of the film.

(II) Forming of Si—O—Si Bond by Hydrolysis and Dehydration Condensation

According to hydrolysis of Si—N bond in perhydropolysilazane by water and breakage of a polymer main chain, Si—OH is formed. According to dehydration condensation of two Si—OH, curing is obtained with forming of Si—O—Si bond. Although the reaction occurs also in air, it is believed that, during vacuum ultraviolet ray irradiation under an inert atmosphere, water vapor generated as an out gas from a substrate caused by heat of irradiation is believed to a main source of moisture. When moisture is present in an excessive amount, Si—OH not consumed by dehydration condensation remains, and thus a curing film with low gas barrier property that is represented by the composition of SiO 2.1 to 2.3 is yielded.

(III) Direct Oxygenation and Forming of Si—O—Si Bond Caused by Singlet Oxygen

When a suitable amount of oxygen is present in an atmosphere during vacuum ultraviolet ray irradiation, singlet oxygen having significantly high oxidizing ability is formed. H and N in perhydropolysilazane are replaced with O to form a Si—O—Si bond, and thus causing curing. It is also considered that recombination of bonds may also occur according to breakage of a polymer main chain.

(IV) Oxidation Accompanied with Si—N Bond Breakage Caused by Vacuum Ultraviolet Ray Irradiation and Excitation

It is believed that, since energy of vacuum ultraviolet ray is greater than the bond energy of Si—N in perhydropolysilazane, Si—N bond is broken and oxidized to generate Si—O—Si bond or Si—O—N bond when an oxygen source such as oxygen, ozone, and water is present in the neighborhood. It is believed that recombination of bonds may also occur according to breakage of a polymer main chain.

Adjusting the composition of silicon oxynitride in a layer which is obtained by performing vacuum ultraviolet ray irradiation on a layer containing polysilazane can be carried out by controlling an oxidation state by combining suitably the oxidation mechanisms (I) to (IV) described above.

Conditions for VUV irradiation of Step (c) (vacuum ultraviolet ray irradiation step) of the present invention are not particularly limited. For example, to have an excellent barrier activity against gas, in particular, water vapor and oxygen, the unmodified layer A (for example, non-crystalline polysilazane layer) is subjected to VUV irradiation via the layer B at a temperature of 150° C. or lower or so, and preferably 120 to 40° C. Accordingly, smooth conversion to a glass type silicon dioxide net-like structure can be obtained. As the oxidative conversion of a polysilazane skeleton to a three-dimensional SiOₓ net-like structure is directly initiated by VUV photons, the conversion is performed within a very short time at a single stage. The mechanism for this conversion process can be described as follows: in a penetration depth range of VUV photons, Si—N bonds are cleaved off and the —SiH₂—NH— constitutional element is strongly excited by its absorption to the level at which layer inversion can occur in the presence of oxygen and water vapor. Meanwhile, the present invention is not limited to the following mechanisms.

The energy amount of vacuum ultraviolet ray irradiation on the layer B is preferably 200 to 5000 mJ/cm², and more preferably 500 to 3000 mJ/cm². With such illuminance, sufficient modification efficiency can be achieved without having a damage on a substrate.

As a vacuum ultraviolet ray source, a rare gas excimer lamp is preferably used. Atoms of rare gas such as Xe, Kr, Ar, or Ne do not create a molecule by chemical bonding, and thus they are referred to as inert gas.

However, the excited atoms of rare gas which have acquired energy by discharge or the like can bind with other atoms to create a molecule. When the rare gas is xenon, it is as described below.

e+Xe→Xe*

Xe*+2Xe→Xe*+Xe

Xe₂*→Xe+Xe+hν(172 nm) [Chemical Formula 12]

When Xe₂* as excited excimer molecule is shifted to a ground state, excimer light of 172 nm is shown.

The Xe excimer lamp radiates ultraviolet ray with single wavelength, that is, short wavelength of 172 nm, and thus the radiation efficiency is excellent. As the light has a high oxygen absorption coefficient, radical oxygen atom species or ozone can be generated even with a tiny amount of oxygen. Further, the light with short wavelength of 172 nm is known to have a high ability of dissociating bonds in an organic compound. Due to high energy of active oxygen or ozone and ultraviolet radiation, the modification of polysilazane layer can be achieved within a short time. Thus, compared to a low pressure mercury lamp having emission from wavelength of 185 nm, 254 nm or plasma cleaning, it enables shortening of time for the processing accompanied with high through-put or decreasing an area for facilities, and irradiation onto an organic material, a plastic substrate, or the like that are prone to suffer from damages caused by heat.

As the excimer lamp has high efficiency of light generation, it is possible to have lighting only with low voltage. Further, as light with long wavelength, which can be a cause of temperature increase by light, is not generated and energy is generated from a single wavelength in an ultraviolet region, it has a characteristic that surface temperature increase in the subject for degradation is suppressed. For such reasons, it is suitable for a flexible film material such as polyethylene terephthalate which is believed to be easily affected by heat. Thus, compared to a low pressure mercury lamp having emission from wavelength of 185 nm, 254 nm or plasma cleaning, it enables shortening of time for the processing accompanied with high through-put or decreasing an area for facilities, and irradiation onto an organic material, a plastic substrate, or the like that are prone to suffer from damages caused by heat.

Further, action of UV light not containing wavelength components of 180 nm or lower from the low pressure mercury lamp from wavelength of 185 nm, 254 nm (HgLP lamp) (185 nm, 254 nm) or KrCl* excimer lamp (222 nm) is limited to direct photodegradation of Si—N bond, and thus it does not generate an oxygen radical or a hydroxyl radical. In such case, as the absorption is negligible enough to be ignored, limitation regarding concentration of oxygen or water vapor is not required. Another advantage of light with shorter wavelength is that it has bigger depth of penetration into a polysilazane layer.

It is preferable that oxygen is present for the reaction by ultraviolet ray irradiation. However, as vacuum ultraviolet ray has absorption by oxygen, efficiency may be easily lowered during vacuum ultraviolet ray irradiation. Thus, vacuum ultraviolet ray irradiation is preferably carried out in a state in which oxygen concentration and water vapor concentration are as low as possible. Namely, oxygen concentration during vacuum ultraviolet ray irradiation is preferably 10 to 210,000 ppm by volume, more preferably 50 to 10,000 ppm by volume, and even more preferably 500 to 5,000 ppm by volume. Furthermore, water vapor concentration during conversion process is preferably in the range of 1000 to 4000 ppm by volume.

Dry inert gas is preferred as a gas satisfying the irradiation atmosphere used for vacuum ultraviolet ray irradiation. In particular, dry nitrogen gas is preferred from the viewpoint of cost, in particular. Adjustment of oxygen concentration can be achieved by changing flow amount ratio after measuring flow amount of oxygen gas and inert gas that are introduced to an irradiation cabin.

In the present invention, forming of a glass type layer with SiOₓN_{y} lattice shape is accelerated by simultaneous increase of a layer temperature, and the quality of the layer is improved in relation to its barrier property. Introduction of heat can be performed through a coating film and a substrate by using a UV lamp or an infrared radiator that are used. Alternatively, it can be performed in a vapor phase space by using a heat resistor. The upper limit of the temperature is determined by the heat resistance of a substrate used. In case of a PET film, it is approximately 180° C.

[Gas Barrier Layer]

The gas barrier layer (in the specification, it is also described as a “gas barrier layer”) according to the present invention is formed by modification of the unmodified layer A, and it is a layer containing SiOₓN_{y}, which has silicon, oxygen, and nitrogen as a main component, and preferably a layer consisting of SiOₓN_{y}. In the specification, the expression “has silicon, oxygen, and nitrogen as a main component” means a component in which total of silicon, oxygen, and nitrogen is preferably 90% by weight or more, more preferably 95% by weight or more, and even more preferably 98% by weight more of the entire elements for constituting the whole layer. Herein, silicon oxynitride (SiOₓN_{y}) has a composition consisting of silicon, oxygen, and nitrogen as main constitutional elements. Each of constitutional elements other than those such as hydrogen or carbon, which is introduced from raw materials for film formation, a substrate, atmosphere, or the like, is preferably lower than 5%, and each of them is preferably lower than 2%. By having such composition (containing nitrogen, in particular), flexibility of the barrier layer is increased to yield higher freedom level of a shape (folding property, bending property, and flexibility). As a result, it is possible to perform curve processing and by having a dense layer, a barrier property against oxygen or water (water vapor) can be improved.

With regard to SiOₓN_{y} for constituting the gas barrier layer, x is preferably 0.5 to 2.3, more preferably 0.5 to 2.0, and even more preferably 1.2 to 2.0. Furthermore, y is preferably 0.001 to 3.0, more preferably 0.001 to 1.5, even more preferably 0.001 to 0.8, and even still more preferably 0.001 to 0.5. Herein, the relationship between x and y is, although not particularly limited, as follows: the compositional ratio of x compared to total of x and y [x/(x+y)] is preferably 0.05 to 0.999, more preferably 0.3 to 0.99, and even more preferably 0.5 to 0.99. Furthermore, the compositional ratio of x compared to y [x/(y)] is preferably 0.2 to 2000, more preferably 0.3 to 100, and particularly preferably 0.5 to 25. Furthermore, when the compositional ratio of x compared to total of x and y [x/(x+y)] and the compositional ratio of x compared to y [x/(y)] are lower than the upper limit, a sufficient gas barrier property can be more easily obtained. Furthermore, when the compositional ratio of x compared to total of x and y [x/(x+y)] and the compositional ratio of x compared to y [x/(y)] are higher than the lower limit, it is unlikely to have a peeling between an organic silicon compound layer when a neighboring substrate is present, and thus it can be suitably applied even for roll conveying or for use under bending.

The refractive index of a gas barrier layer is, although not particularly limited, preferably 1.7 to 2.1, more preferably 1.8 to 2, and particularly preferably 1.9 to 2.0. A gas barrier layer having this refractive index has high visible light transmittance and high gas barrier performance is stably obtained therefrom.

Thickness (coating thickness) of a gas barrier layer can be suitably set depending on the purpose. For example, the thickness (coating thickness) of a gas barrier layer is preferably 1 nm to 100 μm or so, more preferably 10 nm to 10 μm or so, even more preferably 50 nm to 1 μm, and particularly preferably 20 nm to 2 μm in terms of thickness after drying. When the film thickness of a gas barrier layer is 1 nm or more, a sufficient barrier property can be obtained. On the other hand, when it is 100 μm or less, a stable coating property can be obtained during forming of a gas barrier layer, and also high light transmittance can be achieved.

Further, the film density of a gas barrier layer can be suitably set depending on the object. For example, the film density of a gas barrier layer is preferably within a range of from 1.5 to 2.6 g/cm³. When it is not within this range, film composition of a silicon oxynitride (SiOₓN_{y}) film is disturbed and deterioration of a barrier property due to decreased film density or film oxidation deterioration caused by moisture may occur. In the present specification, film composition of a silicon oxynitride (SiOₓN_{y}) film can be measured by photon spectroscopy (XPS), and as a specific device, ESCA3200 manufactured by Shimadzu Corporation can be mentioned. The film density can be measured by X ray reflectivity method, and in the present specification, it is a value (g/cm³) measured by ATX-G manufactured by Rigaku Corporation as a specific measurement device.

The gas barrier layer of the present invention is formed by forming the layer B which contains a compound with an oxygen element or a nitrogen element on top of the unmodified layer A which contains a silicon compound of the formula (1), and performing VUV irradiation from the layer B side.

According to the above process, the unmodified layer A is subjected to a modification treatment by VUV irradiation via the layer B, and thus a gas barrier layer (gas barrier film) with excellent storage stability, in particular, excellent storage stability under harsh conditions (high temperature and high moisture conditions) can be manufactured. Furthermore, because the gas barrier layer (gas barrier film) obtained by the above process exhibits an excellent gas barrier property, that is, water vapor transmission rate (WVTR) of 10⁻⁵ to 10⁻⁶ g/m²/day, it can be preferably used for an organic electroluminescence or the like.

Further, although the gas barrier film of the present invention essentially has a substrate, the modified layer A, and the layer B, it may further contain other member. The gas barrier film of the present invention may contain other member, for example, between a substrate and the modified layer A or the layer B, between the modified layer A and the layer B, or on the other surface of a substrate on which the modified layer A or the layer B is not formed. Herein, other member is not particularly limited, and a member used for a gas barrier film of a related art can be similarly used or it can be used after suitable modification. Specific examples thereof include a under layer, an anchor coat layer, a bleed out preventing layer, a protective layer, and a functionalized layer such as a moisture absorbing layer and an antistatic layer.

[Smooth Layer (Under Layer, Primer Layer)]

The gas barrier film according to the present invention may have a under layer (smooth layer, primer layer) on a substrate surface having a gas barrier layer, preferably between a substrate and a gas barrier layer. The under layer is provided for flattening the rough surface of a substrate, on which projections and the like are present, or flattening a gas barrier layer by filling up unevenness and pinholes generated thereon by projections present on the substrate. Such a under layer can be formed of any material. However, it preferably contains a carbon-containing polymer, and more preferably, it consists of a carbon-containing polymer. Specifically, it is preferable that the gas barrier film of the present invention further has a under layer containing a carbon-containing polymer between a substrate and a gas barrier layer.

Furthermore, the under layer contains a carbon-containing polymer, and preferably a thermosetting resin. The thermosetting resin is not particularly limited, and examples thereof include an active energy ray setting resin which is obtained by irradiating an active energy ray setting resin with active energy ray such as ultraviolet ray and a thermosetting resin which is obtained by heating and setting a thermosetting resin. The setting resin can be used either singly or in combination of two or more types.

Examples of the active energy ray setting material used for forming of the under layer include a resin composition containing an acrylate, a resin composition containing an acrylate compound and a mercapto compound having a thiol group, and a composition with a polyfunctional acrylate monomer such as epoxy acrylate compound, urethane acrylate, polyester acrylate, polyether acrylate, polyethylene glycol acrylate, or glycerol methacrylate. Specifically, a UV curable organic/inorganic hybrid hard coating material OPSTAR (registered trademark) series (a compound obtained by binding an organic compound having a polymerizable unsaturated group to silica microparticles) manufactured by JSR Corporation may be used. Further, any mixture of the compositions described above can also be used, and it is not particularly limited as long as it is an active energy ray setting material containing a reactive monomer having at least one photopolymerizable unsaturated bond in a molecule.

Examples of the reactive monomer having at least one photopolymerizable unsaturated bond in a molecule include methyl acrylate, ethyl acrylate, n-propyl acrylate, isopropyl acrylate, n-butyl acrylate, isobutyl acrylate, tert-butyl acrylate, n-pentyl acrylate, n-hexyl acrylate, 2-ethylhexyl acrylate, n-octyl acrylate, n-decyl acrylate, hydroxyethyl acrylate, hydroxypropyl acrylate, allyl acrylate, benzyl acrylate, butoxyethyl acrylate, butoxyethylene glycol acrylate, cyclohexyl acrylate, dicyclopentanyl acrylate, 2-ethylhexyl acrylate, glycerol acrylate, glycidyl acrylate, 2-hydroxyethyl acrylate, 2-hydroxypropyl acrylate, isobonyl acrylate, isodecyl acrylate, isooctyl acrylate, lauryl acrylate, 2-methoxyethyl acrylate, methoxyethylene glycol acrylate, phenoxyethyl acrylate, stearyl acrylate, ethylene glycol diacrylate, diethylene glycol diacrylate, 1,4-butanediol diacrylate, 1,5-pentanediol diacrylate, 1,6-hexadiol diacrylate, 1,3-propanediol acrylate, 1,4-cyclohexanediol diacrylate, 2,2-dimethylolpropane diacrylate, glycerol diacrylate, tripropylene glycol diacrylate, glycerol triacrylate, trimethylolpropane triacrylate, polyoxyethyltrimethylolpropane triacrylate, pentaerythritol triacrylate, pentaerythritol tetraacrylate, ethylene oxide-modified pentaerythritol triacrylate, ethylene oxide-modified pentaerythritol tetraacrylate, propione oxide-modified pentaerythritol triacrylate, propione oxide-modified pentaerythritol tetraacrylate, triethylene glycol diacrylate, polyoxypropyltrimethylolpropane triacrylate, butylene glycol diacrylate, 1,2,4-butanediol triacrylate, 2,2,4-trimethyl-1,3-pentadiol diacrylate, diallyl fumalate, 1,10-decanediol dimethyl acrylate, pentaerythritol hexaacrylate, those with the acrylate of the above-mentioned monomers replaced by methacrylate, γ-methacryloxypropyltrimethoxysilane and 1-vinyl-2-pyrrolidone. The reactive monomers described above can be used alone or as a mixture of two or more thereof, or a mixture with other compounds.

The composition containing an active energy ray setting material preferably contains a photopolymerization initiator.

Examples of the photopolymerization initiator include benzophenone, methyl o-benzoylbenzoate, 4,4-bis(dimethylamine)benzophenone, 4,4-bis(diethylamine)benzophenone, α-amino-acetophenone, 4,4-dicyclobenzophenone, 4-benzoyl-4-methyldiphenylketone, dibenzylketone, fluorenone, 2,2-diethoxyacetophenone, 2,2-dimethoxy-2-phenylacetophenone, 2-hydroxy-2-methylpropiophenone, p-tert-butyldichloroacetophenone, thioxanthone, 2-methylthioxanthone, 2-chlorothioxanthone, 2-isopropylthioxanthone, diethylthioxanthone, benzyldimethylketal, benzylmethoxyethylacetal, benzoin methyl ether, benzoin butyl ether, anthraquinone, 2-tert-butylanthraquinone, 2-amylanthraquinone, β-chloroanthraquinone, anthrone, benzanthrone, dibenzsuberon, methyleneanthrone, 4-azidobenzylacetophenone, 2,6-bis(p-azidobenzylidene)cyclohexane, 2,6-bis(p-azidobenzylidene)cyclohexane-4-methylcyclohexanone, 2-phenyl-1,2-butanedione-2-(o-methoxycarbonyl)oxime, 1-phenyl-propanedione-2-(o-ethoxycarbonyl)oxime, 1,3-diphenyl-propanetrione-2-(o-ethoxycarbonyl)oxime, 1-phenyl-3-ethoxy-propanetrione-2-(o-benzoyl)oxime, Michler's ketone, 2-methyl[4-(methylthio)phenyl]-2-monopholino-1-propane, 2-benzyl-2-dimethylamino-1-(4-monopholinophenyl)-butanone-1, naphthalenesulfonyl chloride, quinolinesulfonyl chloride, n-phenylthioacridone, 4,4-azobisisobutyronitrile, diphenyl disulfide, benzothiazole disulfide, triphenylphosphine, camphorquinone, carbon tetrabromide, tribromophenylsulfone, benzoin peroxide, and combinations of photo-reductive dyes such as eosin and methylene blue and reducing agents such as ascorbic acid and triethanolamine, and these photopolymerization initiators can be alone or in combination of two or more thereof.

Specific examples of the thermosetting material include Tutoprom series manufactured by Clariant (organic polysilazane), SP COAT heat resistant clear painting manufactured by Ceramic Coat Co., Ltd., nanohybrid silicone manufactured by Adeka Corporation, UNIDIC (registered trademark) V-8000 series manufactured by DIC Corporation, EPICLON (registered trademark) EXA-4710 (ultra high heat resistant epoxy resin), silicon resin X-12-2400 (product name) manufactured by Shin-Etsu Chemical Co., Ltd., inorganic/organic nanocomposite material SSG coat manufactured by Nitto Boseki Co., Ltd., a thermosetting urethane resin consisting of acryl polyol and isocyanate prepolymer, a phenol resin, a urea melamine resin, an epoxy resin, an unsaturated polyester resin, and a silicon resin, and a polyamide amine-epichlorohydrin resin.

The method of forming the under layer is not particularly limited, but a method in which a coating film is formed by coating a coating liquid containing a setting material by a wet coating method such as a spin coating method, a spray coating method, a blade coating method, a wire bar coating method, a dipping method, or a Gravure printing, or a dry coating method such as a vapor deposition method, and the coating film is set and formed by irradiation of active energy ray such as visible ray, infrared ray, ultraviolet ray, X ray, α ray, β ray, γ ray, or electron beam and/or by heating is preferable. Meanwhile, as a method for applying active energy ray, mention can be made for a method in which ultraviolet ray having a wavelength in a range of 100 to 400 nm and preferably of 200 to 400 nm is irradiated by using an ultra-high pressure mercury lamp, a high pressure mercury lamp, a low pressure mercury lamp, a carbon arc, a metal halide lamp or the like, electron beam having a wavelength in a range of 100 nm or less, which is emitted from a scan type or curtain type electron beam accelerator, irradiated.

Examples of the solvent which is used for forming an under layer by using a coating liquid in which a setting material is dissolved or dispersed in a solvent include, although not particularly limited, alcohols such as methanol, ethanol, propanol, isopropyl alcohol, ethylene glycol, and propylene glycol; terpenes such as α- or β-terpineol; ketones such as acetone, methyl ethyl ketone, cyclohexanone, N-methyl-2-pyrrolidone, diethyl ketone, 2-heptanone, and 4-heptanone; aromatic hydrocarbons such as toluene, xylene, and tetramethyl benzene; glycol ethers such as cellosolve, methyl cellosolve, ethyl cellosolve, carbitol, methyl carbitol, ethyl carbitol, butyl carbitol, diethylene glycol dimethyl ether, diethylene glycol diethyl ether, diethylene glycol dipropyl ether, propylene glycol monomethyl ether, propylene glycol monoethyl ether, dipropylene glycol monomethyl ether, dipropylene glycol monoethyl ether, dipropylene glycol dimethyl ether, dipropylene glycol diethyl ether, dipropylene glycol dipropyl ether, triethylene glycol monomethyl ether, and triethylene glycol monoethyl ether; esters such as ethyl acetate, butyl acetate, cellosolve acetate, ethyl cellosolve acetate, butylcellosolve acetate, carbitol acetate, ethyl carbitol acetate, butyl carbitol acetate, propylene glycol monomethyl ether acetate, propylene glycol monoethyl ether acetate, 2-methoxyethyl acetate, cyclohexyl acetate, 2-ethyoxyethyl acetate, 3-methoxybutyl acetate, ethyl-3-ethoxy propionate, and methyl benzoate, N,N-dimethylacetamide and N,N-dimethyl formamide.

The under layer may contain, in addition to the materials described above, additives such as a thermoplastic resin, an antioxidant, a ultraviolet absorbing agent, and a plasticizer. Furthermore, an appropriate resin or additives may be added in order to improve a film forming property, and to suppress generation of pinholes. Examples of the thermoplastic resin include cellulose derivatives such as acetyl cellulose, nitrocellulose, acetyl butyl cellulose, ethyl cellulose and methyl cellulose, vinyl-based resins such as vinyl acetate and copolymers thereof, vinyl chloride and copolymers thereof and vinylidene chloride and copolymers thereof, acetal-based resins such as polyvinyl formal and polyvinyl butyral, acryl-based resins such as an acryl resin and copolymers thereof and a methacryl resin and copolymers thereof, a polystyrene resin, a polyamide resin, a linear polyester resin and a polycarbonate resin.

The smoothness of the under layer is a value expressed by a surface roughness defined in JIS B 0601:2001 and the maximum cross-sectional height Rt (p) is preferably 10 nm to 30 nm.

The surface roughness is measured employing an AFM (atomic force microscope), specifically from a cross-sectional curve of irregularities that is continuously measured by a detector having a probe with extremely small tip radius, and it indicates the roughness regarding amplitude of tiny irregularities after measuring several times a region with measurement direction of several tens of micrometers by a probe with extremely small tip radius.

Film thickness of the under layer is, although not particularly limited, preferably in a range of 0.1 to 10 μm.

[Anchor Coat Layer]

On a surface of the substrate according to the present invention, an anchor coat layer can be formed as an easy adhesion layer for the purpose of enhancing the adhesiveness (adhesion). Examples of the anchor coat agent used for the anchor coat layer include a polyester resin, an isocyanate resin, a urethane resin, an acryl resin, an ethylene vinyl alcohol resin, a vinyl modified resin, an epoxy resin, a modified styrene resin, a modified silicon resin, and alkyl titanate, and one type or two or more types thereof can be used. As an anchor coat agent, a commercially available product can be used. Specifically, a siloxane-based ultraviolet ray curable polymer solution (3% isopropyl alcohol solution of X-12-2400 manufactured by Shin-Etsu Chemical Co., Ltd.) can be used.

A known additive can be added to the anchor coat agent. Further, coating of the anchor coat agent can be performed by coating on a substrate by a known method such as roll coating, Gravure coating, knife coating, dip coating, and spray coating, and drying and removing a solvent, a diluent, or the like. The coating amount of the anchor coat agent is preferably 0.1 to 5 g/m² or so (in dry state). Meanwhile, a commercially available substrate adhered with an easy adhesion layer can be also used.

Alternatively, the anchor coat layer can be also formed by a vapor phase method such as physical vapor deposition method or chemical vapor deposition method. For example, as described in JP 2008-142941 A, an inorganic film having silicon oxide as a main component can be formed for the purpose of improving adhesiveness or the like.

Furthermore, thickness of the anchor coat layer is, although not particularly limited, preferably 0.5 to 10.0 μm or so.

[Bleed Out Preventing Layer]

In the gas barrier film of the present invention, a bleed out preventing layer can be further included. The bleed out preventing layer is provided on the opposite surface of the substrate having an under layer for the purpose of suppressing such a phenomenon that unreacted oligomers and so on are transferred from the interior to the surface of the film substrate to contaminate the contact surface when the film having the smooth layer is heated. The bleed out preventing layer may have essentially the same constitution as that of the smooth layer as long as it has the function described above.

As a compound which can be included in the bleed out preventing layer, a hard coating agent such as a polyvalent unsaturated organic compound having two or more polymerizable unsaturated groups in a molecule or a monovalent unsaturated organic compound having one polymerizable unsaturated group in a molecule can be mentioned.

Here, examples of the polyvalent unsaturated organic compound include ethylene glycol di(meth)acrylate, diethylene glycol di(meth)acrylate, glycerol di(meth)acrylate, glycerol tri(meth)acrylate, 1,4-butanediol di(meth)acrylate, 1,6-hexanediol di(meth)acrylate, neopentyl glycol di(meth)acrylate, trimethylol propane tri(meth)acrylate, dicyclopentanyl di(meth)acrylate, pentaerythritol tri(meth)acrylate, pentaerythritol tetra(meth)acrylate, dipentaerythritol hexa(meth)acrylate, dipentaerythritol monohydroxypenta(meth)acrylate, ditrimethylol propanetetra(meth)acrylate, diethylene glycol di(meth)acrylate, polyethylene glycol di(meth)acrylate, tripropylene glycol di(meth)acrylate, and polypropylene glycol di(meth)acrylate.

Furthermore, examples of the monovalent unsaturated organic compound include methyl(meth)acrylate, ethyl(meth)acrylate, propyl(meth)acrylate, butyl(meth)acrylate, 2-ethylhexyl(meth)acrylate, isodecyl(meth)acrylate, lauryl(meth)acrylate, stearyl(meth)acrylate, allyl(meth)acrylate, cyclohexyl(meth)acrylate, methylcyclohexyl(meth)acrylate, isobornyl(meth)acrylate, 2-hydroxyethyl(meth)acrylate, 2-hydroxypropyl(meth)acrylate, glycerol(meth)acrylate, glycidyl(meth)acrylate, benzyl(meth)acrylate, 2-ethoxyethyl(meth)acrylate, 2-(2-ethoxyethoxyl)ethyl(meth)acrylate, butoxyethyl(meth)acrylate, 2-methoxyethyl(meth)acrylate, methoxydiethylene glycol(meth)acrylate, methoxytriethylene glycol(meth)acrylate, methoxypolyethylene glycol(meth)acrylate, 2-methoxypropyl(meth)acrylate, methoxydipropylene glycol(meth)acrylate, methoxytripropylene glycol(meth)acrylate, methoxypolypropylene glycol(meth)acrylate, polyethylene glycol(meth)acrylate, and polypropylene glycol(meth)acrylate.

As other additives, a matting agent may be contained. As the matting agent, inorganic particles having an average particle diameter of about 0.1 to 5 μm are preferable.

As these inorganic particles, silica, alumina, talk, clay, calcium carbonate, magnesium carbonate, barium sulfate, aluminum hydroxide, titanium dioxide, zirconium oxide and the like can be used alone or in combination of two or more thereof.

Here, it is desirable that the matting agent formed of inorganic particles be mixed at a ratio of 2 parts by weight or more, preferably 4 parts by weight or more, and more preferably 6 parts by weight or more, and 20 parts by weight or less, preferably 18 parts by weight or less, and more preferably 16 parts by weight or less based on 100 parts by weight of the solid content of the hard coating agent.

The bleed out preventing layer may also contain a thermoplastic resin, a thermosetting resin, an ionizing irradiation-curable resin, a photopolymerization initiator and so on as components other than the hard coating agent and matting agent.

Examples of the thermoplastic resin include cellulose derivatives such as acetyl cellulose, nitrocellulose, acetyl butyl cellulose, ethyl cellulose and methyl cellulose, vinyl-based resins such as vinyl acetate and copolymers thereof, vinyl chloride and copolymers thereof and vinylidene chloride and copolymers thereof, acetal-based resins such as polyvinyl formal and polyvinyl butyral, acryl-based resins such as an acryl resin and copolymers thereof and a methacryl resin and copolymers thereof, a polystyrene resin, a polyamide resin, a linear polyester resin and a polycarbonate resin.

Furthermore, examples of the thermosetting resin include a thermosetting urethane resin formed of an acrylic polyol and an isocyanate prepolymer, a phenol resin, a urea melamine resin, an epoxy resin, an unsaturated polyester resin and a silicon resin.

As the ionizing irradiation-curable resin, one that is cured by applying an ionizing irradiation (ultraviolet ray or electron beam) to an ionizing irradiation-curable coating prepared by mixing one or more of photopolymerizable prepolymers, photopolymerizable monomers and so on can be used. An acryl-based prepolymer, which has two or more acryloyl groups in one molecule and is formed into a three-dimensional meshwork structure by crosslinking-curing, is especially suitably used as the photopolymerizable prepolymer. A urethane acrylate, polyester acrylate, epoxy acrylate, melamine acrylate or the like can be used as the acryl-based prepolymer. The polyvalent unsaturated organic compound described above, or the like can be used as the photopolymerizable monomer.

Examples of the photopolymerization initiator include acetophenone, benzophenone, Michler's ketone, benzoin, benzyl methyl ketal, benzoin benzoate, hydroxycyclohexyl phenyl ketone, 2-methyl-1-(4-(methylthio)phenyl)-2-(4-morpholinyl)-1-propane, α-acyloxime ester and thioxanthones.

The bleed out preventing layer described above can be formed by mixing a hard-coating agent and other components as necessary, preparing a coating solution from the mixture with a diluent solvent that is appropriately used as necessary, coating the surface of the substrate film with the coating solution by a previously well-known coating method, and thereafter curing the coated film by applying an ionizing irradiation. A process for applying an ionizing irradiation can be carried out by applying an ultraviolet ray having a wavelength in a range of 100 to 400 nm and preferable of 200 to 400 nm, which is emitted from an ultra-high pressure mercury lamp, a high pressure mercury lamp, a low pressure mercury lamp, a carbon arc, a metal halide lamp or the like, or applying an electron beam having a wavelength in a range of no more than 100 nm, which is emitted from a scan-type or curtain-type electron beam accelerator.

It is desirable that the thickness of the bleed out preventing layer be 1 to 10 μm, and preferably 2 to 7 μm. By ensuring that the thickness is 1 μm or more, the heat resistance as a film is easily made sufficient, and by ensuring that the thickness is 10 μm or less, the balance of the optical characteristics of the smooth film is easily adjusted and curls of the barrier film can be easily suppressed in a case where the smooth layer is provided on one surface of the transparent polymer film.

With regard to the gas barrier film of the present invention, those described in paragraphs [0036] to of JP 2006-289627 A can be suitably employed in addition to those described above.

<Electronic Device>

The gas barrier film of the present invention can be preferably used for a device of which performance is deteriorated by chemical components in the air (oxygen, water, nitrogen oxides, sulfur oxides, ozone, or the like). Examples of the device include an organic EL element, a liquid crystal display element (LCD), a thin film transistor, a touch panel, an electronic paper, and a solar cell (PV). From the viewpoint of obtaining more efficiently the effect of the present invention, it is preferably used for an organic EL element or a solar cell, and particularly preferably for an organic EL element.

The gas barrier film of the present invention can be also used for film sealing of a device. Specifically, it relates to a method for forming a gas barrier film of the present invention on a surface of a device itself as a support. It is also possible that the device is covered with a protective layer before forming a gas barrier film.

The gas barrier film of the present invention can be also used as a substrate of a device or as a film for sealing by solid sealing method. The solid sealing method indicates a method in which a protective layer is formed on a device and a protective layer and a gas barrier film are overlaid followed by setting. The adhesive is not particularly limited, and examples thereof include a thermosetting epoxy resin and a photocurable acrylate resin.

(Organic EL Element)

Examples of an organic EL element using a gas barrier film are described in detail in JP 2007-30387 A.

(Liquid Crystal Display Element)

A reflection type liquid crystal display element has a configuration in which, in the order from the bottom, a base plate, a reflective electrode, a lower orientation film, a liquid crystal layer, an upper orientation film, a transparent electrode, a top plate, a λ/4 plate, and a polarizing plate are included. The gas barrier film of the present invention can be used as a transparent electrode substrate or a top plate. In the case of color display, it is preferable that a color filter layer be further formed between a reflective electrode and a lower orientation film, or between an upper orientation film and a transparent electrode. A transmission type liquid crystal display element has a configuration in which, in the order from the bottom, a backlight, a polarizing plate, a λ/4 plate, a lower transparent electrode, a lower orientation film, a liquid crystal layer, an upper orientation film, an upper transparent electrode, a top plate, a λ/4 plate, and a polarizing plate are included. In the case of color display, it is preferable that a color filter layer be further formed between a lower transparent electrode and a lower orientation film, or between an upper orientation film and a transparent electrode. Type of a liquid crystal is not particularly limited, but it is preferably TN type (Twisted Nematic), STN type (Super Twisted Nematic) or HAN type (Hybrid Aligned Nematic), VA type (Vertically Alignment), ECB type (Electrically Controlled Birefringence), OCB type (Optically Compensated Bend), IPS type (In-Plane Switching), or CPA type (Continuous Pinwheel Alignment).

<Solar Cell>

The gas barrier film of the present invention can be also used as a sealing film of a solar cell element. Herein, it is preferable that the gas barrier film of the present invention be sealed such that the gas barrier layer is present close to a solar cell element. The solar cell element for which the gas barrier film of the present invention is preferably used is not particularly limited, but examples thereof include a monocrystal silicon solar cell element, a polycrystal silicon solar cell element, an amorphous silicon solar cell element consisting of a single attachment type or a tandem structure type, a Group III-V compound semiconductor solar cell element with gallium arsenic (GaAs) or indium phosphorus (InP), Group II-VI compound semiconductor solar cell element with cadmium tellurium (CdTe), Group I-III-VI compound semiconductor solar cell element with copper/indium/selenium system (so called, CIS system), copper/indium/gallium/selenium system (so called, CIGS system), copper/indium/gallium/selenium/sulfur system (so called, CIGSS system), a dye sensitized solar cell element, and an organic solar cell element. Among them, in the present invention, it is preferable that the solar cell element be a Group I-III-VI compound semiconductor solar cell element such as copper/indium/selenium system (so called, CIS system), copper/indium/gallium/selenium system (so called, CIGS system), or copper/indium/gallium/selenium/sulfur system (so called, CIGSS system).

(Others)

Other application examples include a thin film transistor described in JP 10-512104 W, a touch panel described in JP 5-127822 A, JP 2002-48913 A, or the like, and an electronic paper described in JP 2000-98326 A.

<Optical Member>

The gas barrier film of the present invention can be also used as an optical member. Examples of the optical member include a circularly polarizing plate.

(Circularly Polarizing Plate)

By using the gas barrier film of the present invention as a substrate and laminating a λ/4 plate and a polarizing plate, a circularly polarizing plate can be produced. In that case, the lamination is performed such that the slow phase axis of a λ/4 plate and an absorption axis of a polarizing plate form an angle of 45°. As for the polarizing plate, those stretched in 45° direction relative to the length direction (MD) are preferably used, and for example those described in JP 2002-865554 A can be preferably used.

Hereinbelow, the effect of the present invention is described specifically by referring to Examples and Comparative Examples given below, however, the technical scope of the present invention is not limited to Examples. In Examples, the term “parts” or “%” is used. Unless particularly mentioned, this represents “parts by weight” or “% by weight”. Furthermore, unless specifically described otherwise, each operation is performed at room temperature (25° C.)

### Example 1-1

### Production of Gas Barrier Film 1-1

As described below, a substrate was prepared first, and then a gas barrier film was produced by performing a step for forming a gas barrier layer on a substrate.

<<Preparation of Substrate>>

As a thermoplastic resin substrate (support), a polyester film (super-low heat shrinkage PET Q83 manufactured by Teijin DuPont Films Japan Ltd.) having a thickness of 125 μm, of which both surfaces are subjected to an easy adhesion treatment, was used. As described below, a bleed out preventing layer is formed on one surface and a smooth layer is formed on the opposite surface, and then it was used as a substrate.

(Forming of Bleed Out Preventing Layer)

After a UV curable organic/inorganic hybrid hard coating material OPSTARZ7535 (manufactured by JSR Corporation) was coated on one surface of the aforementioned substrate by using a wire bar so as to have a film thickness of 4 μm after drying at temperature of 80° C. for 3 minutes, the resultant was cured in an air atmosphere by using a high pressure mercury lamp at curing conditions; 1.0 J/cm² to form a bleed out preventing layer.

(Forming of Smooth Layer)

Subsequently, after a UV curable organic/inorganic hybrid hard coating material OPSTARZ7501 (manufactured by JSR Corporation) was coated on one surface of the aforementioned substrate by using a wire bar so as to have a film thickness of 4 μm after drying at temperature of 80° C. for 3 minutes, the resultant was cured in an air atmosphere by using a high pressure mercury lamp at curing conditions; 1.0 J/cm² to form a smooth layer.

The maximum cross-sectional height Rt (p) representing surface roughness (defined by JIS B 0601:2001) of the obtained smooth layer was 16 nm. Meanwhile, the surface roughness measurement was carried out by employing an AFM (atomic force microscope) SPI3800N DFM (manufactured by SII). With a single measurement in the range of 80 μm×80 μm, measurement was conducted three times while changing measurement locations. Then, the average of Rt values obtained from each measurement was used as a measurement value.

<<Production of Gas Barrier Layer>>

On top of a smooth layer of the substrate obtained from above, a gas barrier layer was formed according to the following Step (a), (b), and (c).

Step (a): Production of Perhydropolysilazane Layer (the Unmodified Layer A)

On top of a smooth layer of the substrate on which a smooth layer and a bleed out preventing layer are formed, a coating liquid containing perhydropolysilazane (PHPS) was coated according to the following method to form a perhydropolysilazane layer (a layer containing perhydropolysilazane) as the unmodified layer A.

(Coating Liquid Containing Perhydropolysilazane)

The coating liquid containing perhydropolysilazane was prepared as follows: 20% by weight dibutyl ether solution (AQUAMICA NN120-20, produced by AZ electronic materials Co., Ltd.) was used and this solution was diluted with dibutyl ether to adjust PHPS concentration to 10% by weight. Next, by using a roll coater, thus-obtained coating liquid was coated on a surface of a smooth layer of the substrate which has been prepared above. Then, by drying it for 1 minute with dry air having dew point of −5° C., the perhydropolysilazane layer having film thickness (dry film thickness) of 200 nm was prepared as the unmodified layer A. At that time, the perhydropolysilazane layer was not completely solidified.

Step (b): Production of the Layer B

On top of the perhydropolysilazane layer (the unmodified layer A), a coating liquid containing perhydrosilsesquioxane (HSQ) which has been prepared above was coated as follows to prepare HSQ layer as the layer B.

(Coating Liquid Containing Perhydrosilsesquioxane (HSQ))

The coating liquid containing perhydrosilsesquioxane (HSQ) was prepared as follows: by diluting perhydrosilsesquioxane (HSQ) (manufactured by Dow Corning Toray Co., Ltd., product name: Fox-14) with methyl ethyl ketone (MEK; 2-butanone), HSQ concentration was adjusted to 7% by weight. Next, by using a roll coater, thus-obtained coating liquid was coated on a surface of the unmodified layer A which has been prepared above. Then, by drying it for 1 minute with dry air having dew point of −5° C. and for 3 minutes at 80° C., the perhydropolysilazane layer having film thickness (dry film thickness) of 150 nm was prepared as the layer B. At that time, the perhydropolysilazane layer was not completely solidified.

Step (c): Production of Gas Barrier Layer by Modification (Oxidation)

The substrate prepared by the above Step (b) on which the unmodified layer A and the layer B are formed in order was irradiated with vacuum ultraviolet ray (VUV ray) from the layer B side (via the layer B) as described below to modify the perhydropolysilazane layer (the unmodified layer A). As a result, a gas barrier layer was formed.

(Conditions for Vacuum Ultraviolet Ray (VUV Ray) Irradiation Treatment)

Stage-moving type xenon (Xe) excimer illuminator manufactured by M. D. Excimer. Inc. (MODEL: MECL-M-1-200, irradiation wavelength of 172 nm and excimer lamp light intensity of 312 mW/cm²) was used, a sample was fixed such that the irradiation distance between the lamp and the sample is 1 mm, and the sample was reciprocally conveyed at stage moving speed of 20 mm/second while maintaining the sample temperature (stage heating temperature) at 100° C. After 20 reciprocal irradiations in total, the sample was removed.

(Adjustment of Oxygen Concentration)

The oxygen concentration at the time of vacuum ultraviolet ray (VUV ray) irradiation was adjusted as follows: flow amount of nitrogen gas and oxygen gas introduced to a cabin for vacuum ultraviolet ray (VUV ray) irradiation was measured using a flow meter, and the oxygen concentration was adjusted to be in the range of 0.2 to 0.4% by volume (2000 to 4000 ppm by volume) based on the flow amount ratio of the nitrogen gas/oxygen gas introduced to the irradiation cabin.

### Examples 1-2 to 1-14

The gas barrier film 1-2 to 1-14 were produced in the same manner as Example 1-1 except that the O/N containing compound shown in Table 1 below is used instead of HSQ of Example 1-1 and film thickness (dry film thickness) of the layer B is changed to the film thickness (dry film thickness) shown in Table 1. Meanwhile, in the following Table 1, “HSQ” represents perhydropolysilazane Fox-14 (manufactured by Dow Corning Toray Co., Ltd.); “Organosilica sol MEK-ST” represents Organosilica sol MEK-ST (manufactured by Nissan Chemical Industries, Limited, silica gel dispersed in methyl ethyl ketone, SiO₂: 30%, particle diameter: 10 to 20 nm); “X-40-9238” represents X-40-9238 (product name) manufactured by Shin-Etsu Chemical Co., Ltd.; “Aluminum ethylacetoacetate.diisopropylate” represents ALCH (product name) manufactured by Kawaken Fine Chemicals Co., Ltd. (see, the following structural formula); and “HMS-991” represents HMS-991 manufactured by Gelest, Inc. (product name; polymethylhydroxysiloxane, trimethylsilioxy terminal).

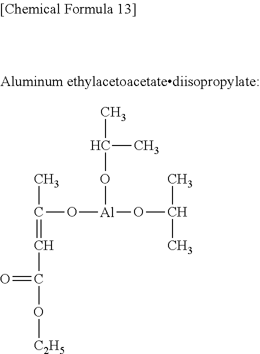

### Example 1-15

### Comparative Example

The gas barrier film 1-15 was produced in the same manner as Example 1-1 except that Step (b) of Example 1-1 is not performed.

### Example 1-16

### Comparative Example

### Preparation of Substrate

A bleed out preventing layer and a smooth layer were formed respectively on two surfaces of a thermoplastic resin substrate (support) in the same manner as Example 1-1 to prepare a substrate.

<<Production of Gas Barrier Layer>>

On top of a smooth layer of the substrate obtained from above, a perhydropolysilazane layer was formed in the same manner as Step (a) of Example 1-1.

Next, the perhydropolysilazane layer of a substrate on which perhydropolysilazane layer has been formed was irradiated with vacuum ultraviolet ray (VUV ray) according to the same irradiation conditions as Step (c) of Example 1-1 to modify the perhydropolysilazane layer. As a result, a modified perhydropolysilazane layer was formed.

Step (b): Production of the Layer B

The organosilica sol layer was formed as the layer B on top of the above modified perhydropolysilazane layer in the same manner as Step (b) of Example 1-1 except that Organosilica sol MEK-ST (manufactured by Nissan Chemical Industries, Limited, silica gel dispersed in methyl ethyl ketone, SiO₂: 30%, particle diameter: 10 to 20 nm) is used instead of perhydrosilsesquioxane (HSQ) of Step (b) of Example 1-1.

Step (c): Production of Gas Barrier Layer by Modification

With regard to Step (c) of Example 1-1, the substrate prepared by the above Step (b) on which the perhydropolysilazane layer and the organosilica sol layer are formed was subjected to VUV ray irradiation at the same conditions as Step (c) of Example 1-1 to produce the gas barrier film 1-16.

### Example 1-17

### Preparation of Substrate

A bleed out preventing layer and a smooth layer were formed respectively on two surfaces of a thermoplastic resin substrate (support) in the same manner as Example 1-1 to prepare a substrate.

<<Production of Gas Barrier Layer>>

Step (a) and (b): Production of Perhydropolysilazane Layer (the Unmodified Layer A) and the Layer B (Two-Layer Laminate)

On top of a smooth layer of the substrate obtained from above on which a bleed out preventing layer and a smooth layer are formed, a perhydropolysilazane layer was formed as the unmodified layer A in the same manner as Step (a) of Example 1-1.

On top of a smooth layer of the substrate on which a bleed out preventing layer and a smooth layer are formed, the coating liquid containing perhydropolysilazane and the coating liquid containing HMS-991 manufactured by Gelest were simultaneously coated to have a multi-layer by using a slide hopper coater capable of performing multi-layer coating. After drying by applying hot air at 80° C., a two-layer laminate of perhydropolysilazane layer (the unmodified layer A) and the HMS-991 layer (the layer B) was formed on top of the smooth layer of the substrate. Meanwhile, “HMS-991” represents HMS-991 manufactured by Gelest, Inc. (product name; polymethylhydroxysiloxane, trimethylsilioxy terminal).

Step (c-2)

Modification was performed in the same manner as Step (c) described in above Example 1-1 to produce a gas barrier layer.

Step (c): Production of Gas Barrier Layer by Modification

With regard to Step (c) of Example 1-1, the substrate prepared by the above Step (a) and Step (b) on which the unmodified layer A and the layer B are formed was subjected to VUV ray irradiation at the same conditions as Step (c) of Example 1-1 to produce the gas barrier film 1-17.

The gas barrier film obtained from above was subjected to evaluation of storage stability and water vapor transmission rate (WVTR) according to the method described below. The results are shown in Table 1 below. Meanwhile, the gas barrier film 1-1 to 1-14 and 1-17 exhibited water vapor transmission rate (WVTR) of 10⁻⁵ to 10⁻⁶ g/m²/day.

<<Method for Evaluating Characteristics of Gas Barrier Film>>

<Storage Stability>

Each gas barrier film was tested for measurement of ATR by using Nicolet 380 manufactured by Thermo Fisher Scientific K.K. Furthermore, the gas barrier film was stored continuously for 120 hours in a high temperature and high humidity chamber (constant temperature and constant humidity oven: Yamato Humidic Chamber IG47M) which has been adjusted to 85° C., 85% RH, and then measured again by ATR method. The ATR spectrum before and after the storage at high temperature and high moisture conditions was normalized against a peak derived from a smooth layer that is observed between 1500 cm⁻¹ and 1800 cm⁻¹, and the change rate of peak intensity derived from Si—N that is detected between 800 cm⁻¹ and 850 cm⁻¹ was calculated according to the following equation (A). Then, it was ranked according to the change rate and the storage stability was evaluated (“storage stability” in the following table).

[Mathematical Formula 1]

Change rate=(Peak intensity after storage under high temperature and high moisture conditions)/(Peak intensity before storage under high temperature and high moisture conditions) Equation (A):

[Chemical Formula 14]

### (Ranking Evaluation of Storage Stability)

1: Change rate is 0.9 or more
2: Change rate is 0.8 or more and lower than 0.9
3: Change rate is 0.7 or more and lower than 0.8
4: Change rate is 0.5 or more and lower than 0.7
5: Change rate is lower than 0.5

<<Water Vapor Transmission Rate (WVTR) Characteristics>>

[Evaluation 1: Evaluation of Bending Resistance (60° C., 90% RH)]

Each gas barrier film was measured for water vapor transmission rate (WVTR) characteristics according to the following methods, and seven-step ranking evaluation was performed as described below to evaluate the gas barrier property.

(Apparatus for Measuring Water Vapor Transmission Rate)

Deposition apparatus: Vacuum deposition apparatus JEE-400 manufactured by JEOL, Ltd.

Constant temperature and humidity oven: Yamato Humidic Chamber IG 47 M.

(Raw Material)

Metal to be corroded by reaction with moisture: calcium (particulate)

Water vapor impermeable metal: aluminum (φ: 3 to 5 mm, particulate)

(Preparation of Cell for Evaluating Water Vapor Barrier Property)

A gas barrier layer surface of a sample was vapor-deposited with metal calcium by using a vacuum deposition apparatus (vacuum vapor deposition apparatus JEE-400 made by JEOL, Ltd.) while masking an area of the gas barrier film sample before attachment of a transparent conductive film except the area desired for vapor deposition (12 mm×12 mm, 9 areas). After that, the mask was removed in vacuum state and aluminum was vapor-deposited on one entire surface of a sheet using another metal vapor deposition source. After aluminum sealing, the vacuum condition was removed. After immediate transfer to a dry nitrogen gas atmosphere, a quartz glass having a thickness of 0.2 mm was brought into contact with the aluminum sealing side via an ultraviolet curing resin for sealing (manufactured by Nagase ChemteX Co., Ltd.), and ultraviolet ray were irradiated to produce a cell for evaluation. Furthermore, in order to determine a change in gas barrier property before and after bending, the gas barrier film not treated with the above bending treatment was also used for producing a cell for evaluating the water vapor barrier property.

Each of the obtained samples (cell for evaluation) of which both surfaces are sealed was stored under high temperature and high moisture condition of 60° C. and 90% RH and, based on the method described in JP 2005-283561 A, the amount of moisture which permeates into the cell was calculated in view of the corrosion amount of the metal calcium. Similarly, each of the obtained samples (cell for evaluation) of which both surfaces are sealed was stored continuously for 120 hours in a high temperature and high humidity chamber (constant temperature and constant humidity oven: Yamato Humidic Chamber IG47M) which has been adjusted to 85° C., 85% RH, and, based on the method described in JP 2005-283561 A, the amount of moisture (permeated moisture amount; unit: g/m²·24 h) which permeates into the cell was calculated in view of the corrosion amount of the metal calcium. Then, the change rate of moisture amount (change rate of WVTR before and after storage under high temperature and high moisture conditions) was calculated according to the following equation (B). Then, it was ranked according to the change rate and the water vapor transmission rate (WVTR) characteristics (“WVTR characteristics” in the following table) were evaluated.

[Mathematical Formula 2]

Change rate=(Permeated moisture amount after storage under high temperature and high moisture conditions)/(Permeated moisture amount before storage under high temperature and high moisture conditions) Equation (B):

[Chemical Formula 15]

### (Ranking Evaluation of WVTR Characteristics)

1: Change rate is 0.8 or more and 1 or less
2: Change rate is 0.7 or more and lower than 0.8
3: Change rate is 0.6 or more and lower than 0.7
4: Change rate is 0.4 or more and lower than 0.6
5: Change rate is 0.2 or more and lower than 0.4
4: Change rate is 0.1 or more and lower than 0.2
5: Change rate is lower than 0.1

TABLE 1

| | | | | | Modification of | | | |
|---|---|---|---|---|---|---|---|---|
| | | | | | layer A by vacuum | | | |
| | | | | Film | ultraviolet ray | WVTR | | |
| | | | | thickness | irradiation via | character- | Storage | |
| | Substrate | Layer A | Layer B | of layer B | layer B (nm) | istics | stability | |
| Example 1-1 | PET | PHPS | HSQ | 150 | Yes | 6 | 4 | Present |
| | | | | | | | | invention |
| Example 1-2 | PET | PHPS | Organo silica sol MEK-ST | 150 | Yes | 6 | 4 | Present |
| | | | | | | | | invention |
| Example 1-3 | PET | PHPS | X-40-9238 | 150 | Yes | 7 | 5 | Present |
| | | | | | | | | invention |
| Example 1-4 | PET | PHPS | Aluminum | 150 | Yes | 6 | 5 | Present |
| | | | ethylacetoacetate•diisopropylate | | | | | invention |
| Example 1-5 | PET | PHPS | Triisopropyl borate | 150 | Yes | 5 | 5 | Present |
| | | | [B(OCH(CH₃)₂)₃]] | | | | | invention |
| Example 1-6 | PET | PHPS | Triisopropyl borate | 5 | Yes | 2 | 2 | Present |
| | | | [B(OCH(CH₃)₂)₃]] | | | | | invention |
| Example 1-7 | PET | PHPS | Triisopropyl borate | 10 | Yes | 4 | 3 | Present |
| | | | [B(OCH(CH₃)₂)₃]] | | | | | invention |
| Example 1-8 | PET | PHPS | Triisopropyl borate | 50 | Yes | 4 | 3 | Present |
| | | | [B(OCH(CH₃)₂)₃]] | | | | | invention |
| Example 1-9 | PET | PHPS | Triisopropyl borate | 100 | Yes | 5 | 4 | Present |
| | | | [B(OCH(CH₃)₂)₃]] | | | | | invention |
| Example 1-10 | PET | PHPS | Triisopropyl borate | 250 | Yes | 5 | 4 | Present |
| | | | [B(OCH(CH₃)₂)₃]] | | | | | invention |
| Example 1-11 | PET | PHPS | Triisopropyl borate | 300 | Yes | 3 | 3 | Present |
| | | | [B(OCH(CH₃)₂)₃]] | | | | | invention |
| Example 1-12 | PET | PHPS | Triisopropyl borate | 500 | Yes | 3 | 2 | Present |
| | | | [B(OCH(CH₃)₂)₃]] | | | | | invention |
| Example 1-13 | PET | PHPS | Triisopropyl borate | 510 | Yes | 2 | 2 | Present |
| | | | [B(OCH(CH₃)₂)₃]] | | | | | invention |
| Example 1-14 | PET | PHPS | Tetramethyldiaminopropane | 150 | Yes | 2 | 2 | Present |
| | | | [CH₃—N(CH₃)—C₃H₆—N(CH₃)—CH₃] | | | | | invention |
| Example 1-15 | PET | PHPS | None | 0 | No | 1 | 1 | Comparative |
| | | | | | | | | Example |
| Example 1-16 | PET | PHPS | Organo silica sol MEK-ST | 150 | No | 2 | 1 | Comparative |
| | | | | | | | | Example |
| Example 1-17 | PET | PHPS | HMS-991 | 150 | Yes | 6 | 4 | Present |
| | | | | | | | | invention |

### Example 2-1

### Preparation of Substrate

A bleed out preventing layer and a smooth layer were formed respectively on two surfaces of a thermoplastic resin substrate (support) in the same manner as Example 1-1 to prepare a substrate.

<<Production of Gas Barrier Layer>>

On top of a smooth layer of the substrate obtained from above, a gas barrier layer was formed according to the following Step (d), (a), (b), and (c).

Step (d): Production of Modified Perhydropolysilazane Layer (First Gas Barrier Layer)

A substrate having a smooth layer and a bleed out preventing layer formed thereon was prepared, and on top of the smooth layer, a coating liquid containing perhydropolysilazane described below was coated to form a perhydropolysilazane layer (a layer containing perhydropolysilazane).

On top of a surface layer of a substrate having a smooth layer and a bleed out preventing layer formed thereon, a coating liquid containing perhydropolysilazane (PHPS) described below was coated according to the following method to form a perhydropolysilazane layer (a layer containing perhydropolysilazane) as the unmodified layer A.

(Coating Liquid Containing Perhydropolysilazane)

The coating liquid containing perhydropolysilazane was prepared as follows: 20% by weight dibutyl ether solution (AQUAMICA NN120-20, produced by AZ electronic materials Co., Ltd.) was used and this solution was diluted with dibutyl ether to adjust PHPS concentration to 10% by weight. Next, by using a roll coater, thus-obtained coating liquid was coated on a surface of a smooth layer of the substrate which has been prepared above. Then, by drying it for 1 minute with dry air having dew point of −5° C., the perhydropolysilazane layer having film thickness (dry film thickness) of 200 nm was prepared. At that time, the perhydropolysilazane layer was not completely solidified.

The substrate having perhydropolysilazane formed thereon was irradiated with vacuum ultraviolet ray (VUV ray) from the perhydropolysilazane layer as described below to modify the perhydropolysilazane layer. As a result, a modified perhydropolysilazane layer (first gas barrier layer) was formed.

(Conditions for Vacuum Ultraviolet Ray (VUV Ray) Irradiation Treatment)

Stage-moving type xenon (Xe) excimer illuminator manufactured by M. D. Excimer. Inc. (MODEL: MECL-M-1-200, irradiation wavelength of 172 nm and excimer lamp light intensity of 312 mW/cm²) was used, a sample was fixed such that the irradiation distance between the lamp and the sample is 1 mm, and the sample was reciprocally conveyed at stage moving speed of 20 mm/second while maintaining the sample temperature (stage heating temperature) at 100° C. After 20 reciprocal irradiations in total, the sample was removed.

(Adjustment of Oxygen Concentration)

The oxygen concentration at the time of vacuum ultraviolet ray (VUV ray) irradiation was adjusted as follows: flow amount of nitrogen gas and oxygen gas introduced to a cabin for vacuum ultraviolet ray (VUV ray) irradiation was measured using a flow meter, and the oxygen concentration was adjusted to be in the range of 0.2 to 0.4% by volume based on the flow amount ratio of the nitrogen gas/oxygen gas introduced to the irradiation cabin.

Step (a): Production of Perhydropolysilazane Layer (the Unmodified Layer A)

On top of the modified perhydropolysilazane layer of the substrate having a smooth layer, a bleed out preventing layer, and a modified perhydropolysilazane layer formed thereon, a perhydropolysilazane layer (the unmodified layer A) was formed in the same manner as Step (a) of Example 1-1.

Step (b): Production of the Layer B

On top of the perhydropolysilazane layer (the unmodified layer A), a coating liquid containing perhydrosilsesquioxane (HSQ) which has been prepared above was coated as follows to prepare HSQ layer as the layer B.

(Coating Liquid Containing Perhydrosilsesquioxane (HSQ))

The coating liquid containing perhydrosilsesquioxane (HSQ) was prepared as follows: by diluting perhydrosilsesquioxane (HSQ) with methyl isobutyl ketone (MIBK; 4-methyl-2-pentanone), HSQ concentration was adjusted to 7% by weight. Next, by using a roll coater, thus-obtained coating liquid was coated on a surface of the unmodified layer A which has been prepared above. Then, by drying it for 1 minute with dry air having dew point of −5° C. and for 3 minutes at 80° C., the perhydropolysilazane layer having film thickness (dry film thickness) of 150 nm was prepared as the layer B. At that time, the perhydropolysilazane layer was not completely solidified.

Step (c): Production of Gas Barrier Layer by Modification (Oxidation)

The substrate prepared by the above Step (b) on which the unmodified layer A and the layer B are formed in order was irradiated with vacuum ultraviolet ray (VUV ray) from the layer B side (via the layer B) as described below to modify the perhydropolysilazane layer (the unmodified layer A). As a result, a gas barrier layer was formed.

(Conditions for Vacuum Ultraviolet Ray (VUV Ray) Irradiation Treatment)

Stage-moving type xenon (Xe) excimer illuminator manufactured by M. D. Excimer. Inc. (MODEL: MECL-M-1-200, irradiation wavelength of 172 nm and excimer lamp light intensity of 312 mW/cm²) was used, a sample was fixed such that the irradiation distance between the lamp and the sample is 1 mm, and the sample was reciprocally conveyed at stage moving speed of 20 mm/second while maintaining the sample temperature (stage heating temperature) at 100° C. After 20 reciprocal irradiations in total, the sample was removed.

(Adjustment of Oxygen Concentration)

The oxygen concentration at the time of vacuum ultraviolet ray (VUV ray) irradiation was adjusted as follows: flow amount of nitrogen gas and oxygen gas introduced to a cabin for vacuum ultraviolet ray (VUV ray) irradiation was measured using a flow meter, and the oxygen concentration was adjusted to be in the range of 0.2 to 0.4% by volume based on the flow amount ratio of the nitrogen gas/oxygen gas introduced to the irradiation cabin.

### Examples 2-2 to 2-11

The gas barrier film 2-2 to 2-11 were produced in the same manner as Example 2-1 except that the O/N containing compound shown in Table 2 below is used instead of HSQ of Example 2-1. Meanwhile, in the following Table 2, “HSQ” represents perhydropolysilazane Fox-14 (manufactured by Dow Corning Toray Co., Ltd.); “Organosilica sol MEK-ST” represents Organosilica sol MEK-ST (manufactured by Nissan Chemical Industries, Limited, silica gel dispersed in methyl ethyl ketone, SiO₂: 30%, particle diameter: 10 to 20 nm); and “X-40-9225” represents X-40-9225 (product name) manufactured by Shin-Etsu Chemical Co., Ltd.

### Example 2-12

### Comparative Example

The gas barrier film 2-12 was produced in the same manner as Example 1-1 except that Step (b) of Example 2-1 is not performed.

### Example 2-13

### Comparative Example

### Preparation of Substrate

A bleed out preventing layer and a smooth layer were formed respectively on two surfaces of a thermoplastic resin substrate (support) in the same manner as Example 1-1 to prepare a substrate.

<<Production of Gas Barrier Layer>>

On top of a smooth layer of the substrate obtained from above, a gas barrier layer was formed according to the following Step (d), (a), (b), and (c).

Step (d): Production of Modified Perhydropolysilazane Layer (First Gas Barrier Layer)

A modified perhydropolysilazane layer (first gas barrier layer) was formed in the same manner as Step (d) of Example 2-1 on top of a smooth layer of a substrate having a smooth layer and a bleed out preventing layer formed thereon.

Step (a): Production of Perhydropolysilazane Layer (Modified Layer)

A perhydropolysilazane layer (the unmodified layer A) was formed in the same manner as Step (a) of Example 2-1 on top of a perhydropolysilazane layer of a substrate having a smooth layer, a bleed out preventing layer, and a modified perhydropolysilazane layer formed thereon.

Next, regarding the substrate having a perhydropolysilazane layer formed thereon, the perhydropolysilazane layer was irradiated with vacuum ultraviolet ray (VUV ray) under the same irradiation conditions as Step (c) of Example 2-1 to modify the perhydropolysilazane layer. As a result, a modified perhydropolysilazane layer was formed.

Step (b): Production of the Layer B

The organosilica sol layer was formed as the layer B on top of the above modified perhydropolysilazane layer in the same manner as Step (b) of Example 2-1 except that Organosilica sol MEK-ST (manufactured by Nissan Chemical Industries, Limited, silica gel dispersed in methyl ethyl ketone, SiO₂: 30%, particle diameter: 10 to 20 nm) is used instead of perhydrosilsesquioxane (HSQ) of Step (b) of Example 2-1.

Step (c): Production of Gas Barrier Layer by Modification

With regard to Step (c) of Example 2-1, the substrate prepared by the above Step (b) on which the perhydropolysilazane layer and the organosilica sol layer are formed was subjected to VUV ray irradiation at the same conditions as Step (c) of Example 2-1 to produce the gas barrier film 2-13.

The gas barrier film obtained from above was subjected to evaluation of storage stability and water vapor transmission rate (WVTR) characteristics according to the method described below. The results are shown in Table 2 below.

TABLE 2

| | | | | | | Modification of | | | |
|---|---|---|---|---|---|---|---|---|---|
| | | First | | | | layer A by vacuum | | | |
| | | gas | | | Film | ultraviolet ray | WVTR | | |
| | Sub- | barrier | Layer | Layer | thickness | irradiation via | character- | Storage | |
| | strate | layer | A | B | of layer B | layer B | istics | stability | |
| Example 2-1 | PET | PHPS | PHPS | HSQ | 200 nm | Yes | 7 | 3 | Present |
| | | | | | | | | | invention |
| Example 2-2 | PET | PHPS | PHPS | Organo silica sol | 200 nm | Yes | 6 | 4 | Present |
| | | | | MEK-ST | | | | | invention |
| Example 2-3 | PET | PHPS | PHPS | Aluminum secondary | 200 nm | Yes | 7 | 5 | Present |
| | | | | butyrate | | | | | invention |
| | | | | [AI(OCH(CH₃)CH₂CH₃] | | | | | |
| Example 2-4 | PET | PHPS | PHPS | Triisopropyl | 200 nm | Yes | 5 | 5 | Present |
| | | | | borate | | | | | invention |
| | | | | [B(OCH(CH₃)₂)₃]] | | | | | |
| Example 2-5 | PET | PHPS | PHPS | Triisopropyl | 80 nm | Yes | 4 | 5 | Present |
| | | | | borate | | | | | invention |
| | | | | [B(OCH(CH₃)₂)₃]] | | | | | |
| Example 2-6 | PET | PHPS | PHPS | Triisopropyl | 40 nm | Yes | 4 | 4 | Present |
| | | | | borate | | | | | invention |
| | | | | [B(OCH(CH₃)₂)₃]] | | | | | |
| Example 2-7 | PET | PHPS | PHPS | Triisopropyl | 10 nm | Yes | 4 | 3 | Present |
| | | | | borate | | | | | invention |
| | | | | [B(OCH(CH₃)₂)₃]] | | | | | |
| Example 2-8 | PET | PHPS | PHPS | Triisopropyl | 330 nm | Yes | 4 | 4 | Present |
| | | | | borate | | | | | invention |
| | | | | [B(OCH(CH₃)₂)₃]] | | | | | |
| Example 2-9 | PET | PHPS | PHPS | Triisopropyl | 200 nm | Yes | 5 | 5 | Present |
| | | | | borate | | | | | invention |
| | | | | [B(OCH(CH₃)₂)₃]] | | | | | |
| Example 2-10 | PET | PHPS | PHPS | Tetramethyldiaminopropane | 200 nm | Yes | 3 | 2 | Present |
| | | | | [CH₃—N(CH₃)—C₃H₆—N(CH₃)—CH₃] | | | | | invention |
| Example 2-11 | PET | PHPS | PHPS | X-40-92225 | 200 nm | Yes | 7 | 5 | Present |
| | | | | | | | | | invention |
| Example 2-12 | PET | PHPS | PHPS | None | 0 nm | No | 1 | 1 | Compar- |
| | | | | | | | | | ative |
| | | | | | | | | | Example |
| Example 2-13 | PET | PHPS | PHPS | Organo silica sol | 200 nm | No | 1 | 1 | Compar- |
| | | | | MEK-ST | | | | | ative |
| | | | | | | | | | Example |

The present application is based on Japanese Patent Application No. 2013-003636 filed on Jan. 11, 2013, and its disclosure is incorporated herein by reference in its entirety.

### REFERENCE SIGNS LIST

11 Gas barrier film
12 Substrate
13 Gas barrier layer
14 Layer B

1. A process for manufacturing a gas barrier film comprising:
(a) forming, on a substrate, an unmodified layer A which contains a silicon compound having a structure represented by the following General Formula (1),
[Chemical Formula 1]
—[Si(R¹)(R²)—N(R³)]ₙ— General Formula (1)
wherein R¹, R², and R³ each independently represent a hydrogen atom, a substituted or unsubstituted alkyl group, a substituted or unsubstituted aryl group, a substituted or unsubstituted vinyl group, or a substituted or unsubstituted (trialkoxysilyl)alkyl group, and n is an integer representing the number of a constitutional unit having the formula of —[Si(R¹)(R²)—N(R³)]—;
(b) forming a layer B which contains a compound having an oxygen element or a nitrogen element on the unmodified layer A; and
(c) irradiating with vacuum ultraviolet ray from the layer B side to modify the unmodified layer A.

2. The process according to claim 1, wherein the compound having an oxygen element or a nitrogen element is at least one selected from a group consisting of metal oxide, alkoxide of an alkali metal, a metal compound having a constitutional unit represented by the following General Formula (2):
[Chemical Formula 2]
R⁵-[M(R⁴)ₙ₁—Yₙ₂]ₙ—R⁶ General Formula (2)
wherein M represents barium (Ba), magnesium (Mg), silicon (Si), aluminum (Al), boron (B), iron (Fe), cobalt (Co), titan (Ti), zirconium (Zr), nickel (Ni), copper (Cu), zinc (Zn), indium (In), chrome (Cr), manganese (Mn), ruthenium (Ru), rhodium (Rh), palladium (Pd), iridium (Ir), or platinum (Pt); Y represents a single bond or an oxygen atom (—O—); R⁴, R⁵, and R⁶ each independently represent a hydrogen atom, a halogen atom, a cyano group, a nitro group, a mercapto group, an epoxy group, a hydroxyl group, a substituted or unsubstituted alkyl group with 1 to 10 carbon atoms, a substituted or unsubstituted cycloalkyl group with 3 to 10 carbon atoms, a substituted or unsubstituted alkenyl group with 2 to 10 carbon atoms, a substituted or unsubstituted alkynyl group with 2 to 10 carbon atoms, a substituted or unsubstituted alkoxy group with 1 to 10 carbon atoms, a substituted or unsubstituted (alkyl)acetoacetate group with 4 to 25 carbon atoms, a substituted or unsubstituted aryl group with 6 to 30 carbon atoms, a substituted or unsubstituted heterocyclic group or an amino group; m1 and m2 are each independently an integer of 1 or more and m1+m2 is an integer which is determined by M; and n is an integer of 1 or more,
a primary amine compound, a secondary amine compound, a tertiary amine compound, and a diamine compound represented by the following General Formula (3): 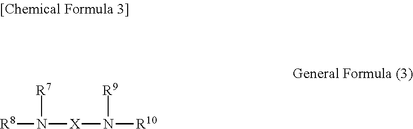
wherein R⁷ to R¹⁰ each independently represent a substituted or unsubstituted alkyl group with 1 to 10 carbon atoms, a substituted or unsubstituted cycloalkyl group with 3 to 10 carbon atoms, a substituted or unsubstituted alkenyl group with 2 to 10 carbon atoms, a substituted or unsubstituted alkynyl group with 2 to 10 carbon atoms, a substituted or unsubstituted alkoxy group with 1 to 10 carbon atoms, a substituted or unsubstituted aryl group with 6 to 30 carbon atoms, or a substituted or unsubstituted heterocyclic group; and X represents a substituted or unsubstituted alkylene group with 1 to 10 carbon atoms, or an imino group (—C(═NH)—).

3. The process according to claim 2, wherein the compound having an oxygen element or a nitrogen element is at least one selected from a group consisting of silicon oxide, perhydrosilsesquioxane, and a metal compound having a constitutional unit represented by General Formula (2) in which M is silicon (Si), aluminum (Al), or boron (B) and at least one of R⁴, R⁵, and R⁶ is an alkyl group with 1 to 10 carbon atoms or an alkoxy group with 1 to 10 carbon atoms.

4. The process according to claim 1, wherein the layer B has thickness (dry film thickness) of 10 to 500 nm.

5. A gas barrier film manufactured by the process according to claim 1.

6. The process according to claim 2, wherein the layer B has thickness (dry film thickness) of 10 to 500 nm.

7. A gas barrier film manufactured by the process according to claim 2.

8. The process according to claim 3, wherein the layer B has thickness (dry film thickness) of 10 to 500 nm.

9. A gas barrier film manufactured by the process according to claim 3.

10. A gas barrier film manufactured by the process according to claim 4.
